(19) United States
(12) Patent Application Publication
(10) Pub. No.: US 2026/0230903 A1
(43) Pub. Date: Aug. 6, 2026

(54) QUALITY OF SERVICE (QOS) PROFILES FOR USER EXPERIENCE AWARENESS

(71) Applicant: QUALCOMM Incorporated, San Diego, CA (US)

(72) Inventors: Hyun Yong LEE, San Diego, CA (US); Hong CHENG, Basking Ridge, NJ (US); Belal Salama Amin KORANY, San Diego, CA (US); Prashanth Haridas HANDE, San Diego, CA (US); Peerapol TINNAKORNSRISUPHAP, San Diego, CA (US)

(21) Appl. No.: 19/044,347

(22) Filed: Feb. 3, 2025

(51) Int. Cl. H04W 28/02; H04L 41/5067; H04M 15/00

(52) U.S. Cl. CPC H04W 28/0268; H04L 41/5067; H04M 15/66

(57) ABSTRACT

Methods, systems, and devices for wireless communications are described. An application server may output, to one or more network nodes of a wireless communications system, a first message indicating a set of quality of service (QoS) profiles for operations at a user equipment (UE), where the each QoS profile indicates a respective bitrate corresponding to a respective quality of experience (QoE) level for operations at the UE. The one or more network nodes may select a QoS profile for the operations at the UE based on the bitrates and QoE levels, and may output a second message to the application server indicating the selected QoS profile. The application server and the UE may then communicate with one another (via the one or more network nodes) in accordance with the indicated/selected QoS profile

### FIELD OF TECHNOLOGY

The following relates to wireless communications, including quality of service (QoS) profiles for user experience (UX) awareness.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by an application server is described. The method may include outputting, to one or more network nodes of a wireless communications system, a first message indicative of a set of multiple quality of service (QoS) profiles for operations at a user equipment (UE), where the set of multiple QoS profiles each indicate a respective bitrate corresponding to a respective quality of experience (QoE) level for operations at the UE, obtaining a second message indicative of a QoS profile selected from the set of multiple QoS profiles, the QoS profile including a first bitrate configured to maintain a first QoE level at the UE, and communicating data with the UE via the one or more network nodes in accordance with the QoS profile indicated via the second message.

An application server for wireless communications is described. The application server may include one or more memories storing processor executable code, and one or more processors coupled with the one or more memories. The one or more processors may individually or collectively be operable to execute the code to cause the application server to output, to one or more network nodes of a wireless communications system, a first message indicative of a set of multiple QoS profiles for operations at a UE, where the set of multiple QoS profiles each indicate a respective bitrate corresponding to a respective QoE level for operations at the UE, obtain a second message indicative of a QoS profile selected from the set of multiple QoS profiles, the QoS profile including a first bitrate configured to maintain a first QoE level at the UE, and communicate data with the UE via the one or more network nodes in accordance with the QoS profile indicated via the second message.

Another application server for wireless communications is described. The application server may include means for outputting, to one or more network nodes of a wireless communications system, a first message indicative of a set of multiple QoS profiles for operations at a UE, where the set of multiple QoS profiles each indicate a respective bitrate corresponding to a respective QoE level for operations at the UE, means for obtaining a second message indicative of a QoS profile selected from the set of multiple QoS profiles, the QoS profile including a first bitrate configured to maintain a first QoE level at the UE, and means for communicating data with the UE via the one or more network nodes in accordance with the QoS profile indicated via the second message.

A non-transitory computer-readable medium storing code for wireless communications is described. The code may include instructions executable by one or more processors to output, to one or more network nodes of a wireless communications system, a first message indicative of a set of multiple QoS profiles for operations at a UE, where the set of multiple QoS profiles each indicate a respective bitrate corresponding to a respective QoE level for operations at the UE, obtain a second message indicative of a QoS profile selected from the set of multiple QoS profiles, the QoS profile including a first bitrate configured to maintain a first QoE level at the UE, and communicate data with the UE via the one or more network nodes in accordance with the QoS profile indicated via the second message.

In some examples of the method, application servers, and non-transitory computer-readable medium described herein, the first message includes an application function session with QoS (AFSessionWithQoS) message. In some cases, the first message may include application function with QoS-create (AFSessionWithQoS-Create) and/or application function with QoS-update (AFSessionWithQoS-Update) messages (e.g., Nnef_AFsessionWithQoS_Create request, Nnef_AFSessionWithQoS_Update request), or both.

In some examples of the method, application servers, and non-transitory computer-readable medium described herein, the first message indicates a QoE-bitrate curve associated with the set of multiple QoS profiles, the QoE-bitrate curve indicating a set of multiple bitrates and a set of multiple QoE metrics corresponding to the set of multiple bitrates for the operations at the UE.

Some examples of the method, application servers, and non-transitory computer-readable medium described herein may further include operations, features, means, or instructions for outputting, to one or more network nodes of a wireless communications system, a third message indicating an update to the QoS profile, where the update indicates an updated QoE level corresponding to the first bitrate associated with the QoS profile, where the third message may be output based on an update periodicity associated with the operations at the UE, one or more application content changes associated with the operations at the UE, or both.

Some examples of the method, application servers, and non-transitory computer-readable medium described herein may further include operations, features, means, or instructions for obtaining, from the one or more network nodes, an indication of a QoE metric associated with communications between the UE and the one or more network nodes, where the third message may be output based on the indication of the QoE metric.

In some examples of the method, application servers, and non-transitory computer-readable medium described herein, the one or more application content changes include one or more changes in video content complexity, extended reality (XR) content complexity, virtual reality (VR) content complexity, mixed reality content complexity, one or more changes in streaming content, or any combination thereof.

In some examples of the method, application servers, and non-transitory computer-readable medium described herein, the first message further includes an indication of a time duration over which the respective bitrates and the respective QoE levels associated with the set of multiple QoS profiles may be expected to be maintained.

In some examples of the method, application servers, and non-transitory computer-readable medium described herein, the respective QoE levels of the set of multiple QoS profiles may be associated with one or more QoS identifiers in accordance with one or more policy and charging control (PCC) configurations.

In some examples of the method, application servers, and non-transitory computer-readable medium described herein, the respective QoE levels of the set of multiple QoS profiles include minimum target QoE levels, ranges of QoE values, or both.

In some examples of the method, application servers, and non-transitory computer-readable medium described herein, the first message includes a packet data unit (PDU) set metadata indicative of data traffic at the UE.

In some examples of the method, application servers, and non-transitory computer-readable medium described herein, the first message further indicates one or more prioritization metrics corresponding to the set of multiple QoS profiles and the selection of the QoS profile from the set of multiple QoS profiles may be based on the one or more prioritization metrics.

In some examples of the method, application servers, and non-transitory computer-readable medium described herein, the one or more network nodes include a Network Exposure Function (NEF) node, a Policy Control Function (PCF) node, Session Management Function (SMF) node, an Access and Mobility Management Function (AMF) node, a Unified Data Management (UDM) node, a Radio Access Network (RAN) node, or any combination thereof.

In some examples of the method, application servers, and non-transitory computer-readable medium described herein, the set of multiple QoS profiles may be associated with one or more QoS flows and the one or more QoS flows correspond to one or more service data flows (SDFs) based on the respective QoE levels of the set of multiple QoS profiles.

Some examples of the method, application servers, and non-transitory computer-readable medium described herein may further include operations, features, means, or instructions for transmitting, to the one or more network nodes and in response to the second message indicative of the QoS profile, an application function session with QoS-create (AFSessionWithQoS-Create) message, an application function session with QoS-update (AFSessionWithQoS-Update) message, or both. Additionally, or alternatively, a new AFSessionWithQoS can be introduced for the second message.

In some examples of the method, application servers, and non-transitory computer-readable medium described herein, the one or more QoS profiles include one or more alternative QoS profiles usable for communications between a Session Management Function (SMF) node and a Radio Access Network (RAN) node.

A method for wireless communications by a network node is described. The method may include obtaining, from an application server, a first message indicative of a set of multiple QoS profiles for operations at a UE, where the set of multiple QoS profiles each indicate a respective bitrate corresponding to a respective QoE level for operations at the UE, outputting a second message indicative of a QoS profile selected from the set of multiple QoS profiles, the QoS profile including a first bitrate configured to maintain a first QoE level at the UE, and communicating data between the application server and the UE in accordance with the QoS profile indicated via the second message.

A network node for wireless communications is described. The network node may include one or more memories storing processor executable code, and one or more processors coupled with the one or more memories. The one or more processors may individually or collectively be operable to execute the code to cause the network node to obtain, from an application server, a first message indicative of a set of multiple QoS profiles for operations at a UE, where the set of multiple QoS profiles each indicate a respective bitrate corresponding to a respective QoE level for operations at the UE, output a second message indicative of a QoS profile selected from the set of multiple QoS profiles, the QoS profile including a first bitrate configured to maintain a first QoE level at the UE, and communicate data between the application server and the UE in accordance with the QoS profile indicated via the second message.

Another network node for wireless communications is described. The network node may include means for obtaining, from an application server, a first message indicative of a set of multiple QoS profiles for operations at a UE, where the set of multiple QoS profiles each indicate a respective bitrate corresponding to a respective QoE level for operations at the UE, means for outputting a second message indicative of a QoS profile selected from the set of multiple QoS profiles, the QoS profile including a first bitrate configured to maintain a first QoE level at the UE, and means for communicating data between the application server and the UE in accordance with the QoS profile indicated via the second message.

A non-transitory computer-readable medium storing code for wireless communications is described. The code may include instructions executable by one or more processors to obtain, from an application server, a first message indicative of a set of multiple QoS profiles for operations at a UE, where the set of multiple QoS profiles each indicate a respective bitrate corresponding to a respective QoE level for operations at the UE, output a second message indicative of a QoS profile selected from the set of multiple QoS profiles, the QoS profile including a first bitrate configured to maintain a first QoE level at the UE, and communicate data between the application server and the UE in accordance with the QoS profile indicated via the second message.

In some examples of the method, network nodes, and non-transitory computer-readable medium described herein, the first message includes an AFSessionWithQoS message. In some cases, the first message may include AFSessionWithQoS-Create and/or AFSessionWithQoS-Update messages (e.g., Nnef_AFsessionWithQoS_Create request, Nnef_AFSessionWithQoS_Update request), or both.

In some examples of the method, network nodes, and non-transitory computer-readable medium described herein, the first message indicates a QoE-bitrate curve associated with the set of multiple QoS profiles, the QoE-bitrate curve indicating a set of multiple bitrates and a set of multiple QoE metrics corresponding to the set of multiple bitrates for the operations at the UE.

Some examples of the method, network nodes, and non-transitory computer-readable medium described herein may further include operations, features, means, or instructions for obtaining, from the application server, a third message indicating an update to the QoS profile, where the update indicates an updated QoE level corresponding to the first bitrate associated with the QoS profile, where the third message may be obtained based on an update periodicity associated with the operations at the UE, one or more application content changes associated with the operations at the UE, or both.

Some examples of the method, network nodes, and non-transitory computer-readable medium described herein may further include operations, features, means, or instructions for outputting, to the application server, an indication of a QoE metric associated with communications between the UE and the network node, where the third message may be obtained based on outputting the indication of the QoE metric.

Some examples of the method, network nodes, and non-transitory computer-readable medium described herein may further include operations, features, means, or instructions for obtaining, from the UE, a report indicating the QoE metric associated with the communications between the UE and the network node, where the indication of the QoE metric may be output to the application server may be based on obtaining the report.

In some examples of the method, network nodes, and non-transitory computer-readable medium described herein, the one or more application content changes include one or more changes in video content complexity, XR content complexity, VR content complexity, mixed reality content complexity, one or more changes in streaming content, or any combination thereof.

In some examples of the method, network nodes, and non-transitory computer-readable medium described herein, the first message further includes an indication of a time duration over which the respective bitrates and the respective QoE levels associated with the set of multiple QoS profiles may be expected to be maintained.

In some examples of the method, network nodes, and non-transitory computer-readable medium described herein, the respective QoE levels of the set of multiple QoS profiles may be associated with one or more QoS identifiers in accordance with one or more PCC configurations.

In some examples of the method, network nodes, and non-transitory computer-readable medium described herein, the respective QoE levels of the set of multiple QoS profiles include minimum target QoE levels, ranges of QoE values, or both.

In some examples of the method, network nodes, and non-transitory computer-readable medium described herein, the first message further includes a PDU set metadata indicative of data traffic at the UE.

In some examples of the method, network nodes, and non-transitory computer-readable medium described herein, the first message further indicates one or more prioritization metrics corresponding to the set of multiple QoS profiles and the selection of the QoS profile from the set of multiple QoS profiles may be based on the one or more prioritization metrics.

In some examples of the method, network nodes, and non-transitory computer-readable medium described herein, the network node includes a NEF node, a PCF node, an SMF node, an AMF node, a UDM node, a RAN node, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports quality of service (QoS) profiles for user experience (UX) awareness in accordance with one or more aspects of the present disclosure.

FIG. 2 shows an example of a network architecture that supports QoS profiles for UX awareness in accordance with one or more aspects of the present disclosure.

FIG. 3 shows an example of a wireless communications system that supports QoS profiles for UX awareness in accordance with one or more aspects of the present disclosure.

FIG. 4 shows an example of a wireless communications system that supports QoS profiles for UX awareness in accordance with one or more aspects of the present disclosure.

FIG. 5 shows an example of a process flow that supports QoS profiles for UX awareness in accordance with one or more aspects of the present disclosure.

FIGS. 6 and 7 show block diagrams of devices that support QoS profiles for UX awareness in accordance with one or more aspects of the present disclosure.

FIG. 8 shows a block diagram of a communications manager that supports QoS profiles for UX awareness in accordance with one or more aspects of the present disclosure.

FIG. 9 shows a diagram of a system including a device that supports QoS profiles for UX awareness in accordance with one or more aspects of the present disclosure.

FIGS. 10 and 11 show flowcharts illustrating methods that support QoS profiles for UX awareness in accordance with one or more aspects of the present disclosure.

### DETAILED DESCRIPTION

A wireless communications system may support advanced technologies to enable implementation of a cyber-physical network. For example, the wireless communications system may support immersive applications such as immersive virtual reality (VR) applications, augmented reality (AR) applications, extended reality (XR) applications, mixed reality applications, interactive mapping, integration of artificial intelligence, among other applications. In some aspects, immersive applications may utilize high reliability latency-bound (e.g., real-time) video streams which require little to no buffering and relatively high data rates. For such applications and other advanced technologies, it is important to maintain acceptable levels of user experience and quality of experience (QoE), for example, maintaining user experience and QoE at or above a quality threshold.

In some implementations, the wireless communications system may utilize measurements of data rate and latency, among other quality-based measurement frameworks, in order to evaluate QoE for various applications run at a user equipment (UE). However, for a given bitrate, the QoE experienced at respective UEs may be different based on the content and codec of the operations at the respective UEs. That is, due to differences in content between a first UE and a second UE, a bitrate of 5 Mbps may result in a low QoE at the first UE, and may result in a relatively higher QoE at the second UE.

To support enhanced QoE and increased overall user experience for immersive applications and other advanced technologies for users, the wireless communications system may support radio access node (RAN)-assisted QoE-aware source bitrate selection to provide high quality services for multiple UEs. In particular, aspects of the present disclosure are directed to quality of service (QoS) profiles that include information regarding bitrates and corresponding QoE levels for operations at a UE. Using such QoS profiles, a wireless communications system may support granular coordination between a RAN node, an application server, and UEs, to more effectively select a QoS profile for operations at a UE to improve QoE and user experience (UX) at the UE.

For instance, an application function/server may estimate varying QoE levels for a UE as a function of bitrates (e.g., for the next N frames or time segments), and may output one or more QoS profiles that include the bitrate-QoE level information to the network node(s). That is, each QoS profile may include a bitrate and a corresponding QoE level that is achievable at the UE using the respective bitrate. The network node(s) may select one of the QoS profiles for communications between the UE and the application function/server, such as based on channel conditions, network congestion, etc. For instance, the network node(s) may implement one or more QoS profile selection algorithms to select QoS profiles for UEs to increase or maximize the total number of UEs that are successfully able to obtain and maintain a threshold QoE. The network node(s) may then indicate the selected QoS profile to the application function/server, which may then communicate data (e.g., data for AR/VR services) with the UE in accordance with the selected/indicated QoS profile.

For the purposes of the present disclosure, the terms “QoE” and “UX” may be used to refer to the relative quality of applications/functions (e.g., video applications such as AR/VR applications, audio applications, etc.) executable at a UE. In this regard, the terms “QoE” and “UX” may generally be used interchangeably to refer to metrics that may be measured/observed, such as service quality, latency, data rate, buffering rate, and the like. For example, the term “QoE level” may refer to a single metric (or a set of metrics) that quantifies the relative QoE/UX that is experienced or observed at a UE. That is, in some cases, a “QoE level” may include a single QoE metric (such as data rate), whereas in other cases, a “QoE level” may be determined based on a combination of multiple QoE metrics. In this regard, a first QoE level may be said to be “higher” or “better” than a second QoE level if at least one metric (e.g., data rate, service quality, latency) associated with the first QoE level exhibits a relatively higher UX as compared to a corresponding metric associated with the second QoE level. For instance, the first QoE level may be said to be “higher” or “better” than the second QoE level if the first QoE level is associated with a higher data rate and/or a lower latency at the UE as compared to the second QoE level.

Aspects of the disclosure may be implemented to realize one or more potential advantages. For example, RAN-assisted QoE-aware QoS profile selection techniques may provide higher quality video streaming and other low latency services for multiple users in a system by more effectively allocating system bitrates across different UEs. For example, the RAN node may be able to tailor QoS profiles that are used to facilitate communications with various UEs to more evenly distribute bitrates for users so that relatively more users maintain a threshold QoE. Additionally, or alternatively, the techniques described herein may allow for more adaptable bitrate delivery based on content changes. For example, changes in streaming content or content complexity may be more effectively identified and QoS profiles may be selected and/or modified based on content changes. Additionally, or alternatively, the techniques described herein may allow for increased RAN-level awareness of QoE for multiple users, which may allow for more balanced resource allocation throughout a wireless system.

Aspects of the disclosure are initially described in the context of wireless communications systems. Additional aspects of the disclosure are further described in the context of an example process flow. Aspects of the disclosure are further illustrated by and described with reference to apparatus diagrams, system diagrams, and flowcharts that relate to QoS profiles for UX awareness.

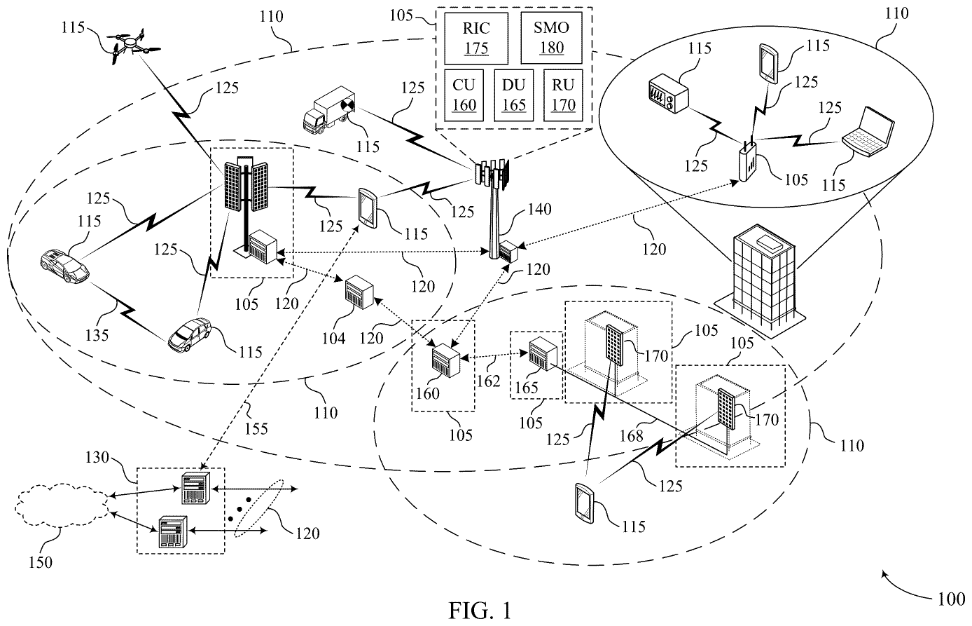

FIG. 1 shows an example of a wireless communications system 100 that supports QoS profiles for UX awareness in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support QoS profiles for UX awareness as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support advanced technologies including immersive applications (e.g., virtual realities, extended reality, mixed reality, interactive mapping, integration of artificial intelligence, among other applications). In some aspects, immersive applications may utilize high reliability latency-bound video streams which require little to no buffering and relatively high data rates, and high QoE. In some implementations, the wireless communications system 100 may utilize measurements of data rate and latency, among other quality-based measurement frameworks, in order to evaluate QoE for various applications run at a UE 115. In some cases, however, measurements of data rate and latency (among other metrics) may be inadequate to fully evaluate QoE for UEs running different applications. That is, evaluations of some QoS-based metrics may be inadequate to maintain acceptable QoE due to frequent channel variation and network loading conditions. Additionally, or alternatively, an application server generating video or streaming traffic may be configured separate from the RAN, which may cause challenges for effectively maintaining high quality content for multiple UEs in a system. Moreover, for a given bitrate, the QoE experienced at respective UEs 115 may be different based on the content and codec of the operations at the respective UEs. That is, due to differences in content between a first UE 115 and a second UE 115, a bitrate of 5 Mbps may result in a low QoE at the first UE 115, and may result in a relatively higher QoE at the second UE 115.

To support enhanced QoE and increased overall user experience for immersive applications and other advanced technologies for users, the wireless communications system 100 may support RAN-assisted QoE-aware source bitrate selection to provide high quality services for multiple UEs 115. In particular, the wireless communications system 100 may support QoS profiles that include information regarding bitrates and corresponding QoE levels for operations at a UE 115. Using such QoS profiles, the wireless communications system 100 may support granular coordination between a RAN node, an application server, and UEs 115, to more effectively select a QoS profile for operations at the UEs 115 to improve QoE and UX at the UEs 115.

For instance, an application function/server of the wireless communications system 100 may estimate varying QoE levels for a UE 115 as a function of bitrates (e.g., for the next N frames or time segments), and may output one or more QoS profiles that include the bitrate-QoE level information to the network node(s). That is, each QoS profile may include a bitrate and a corresponding QoE level that is achievable at the UE 115 using the respective bitrate. The network node(s) may select one of the QoS profiles for communications between the UE 115 and the application function/server, such as based on channel conditions, network congestion, etc. For instance, the network node(s) may implement one or more QoS profile selection algorithms to select QoS profiles for UEs 115 to increase or maximize the total number of UEs 115 that are successfully able to obtain and maintain a threshold QoE. The network node(s) may then indicate the selected QoS profile to the application function/server, which may then communicate data (e.g., data for AR/VR services) with the UE 115 in accordance with the selected/indicated QoS profile.

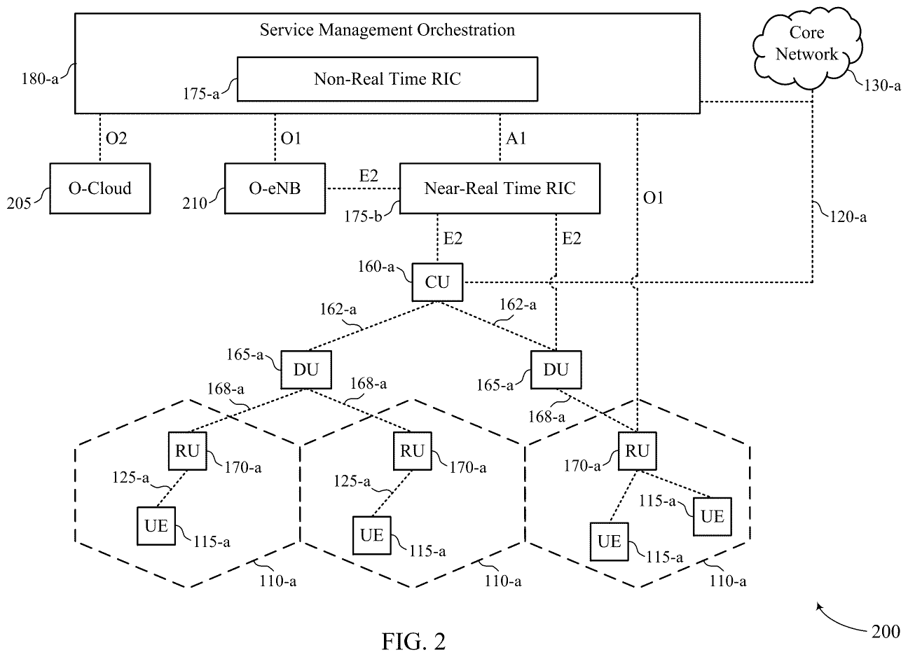

FIG. 2 shows an example of a network architecture 200 (e.g., a disaggregated base station architecture, a disaggregated RAN architecture) that supports QoS profiles for UX awareness in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115 via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

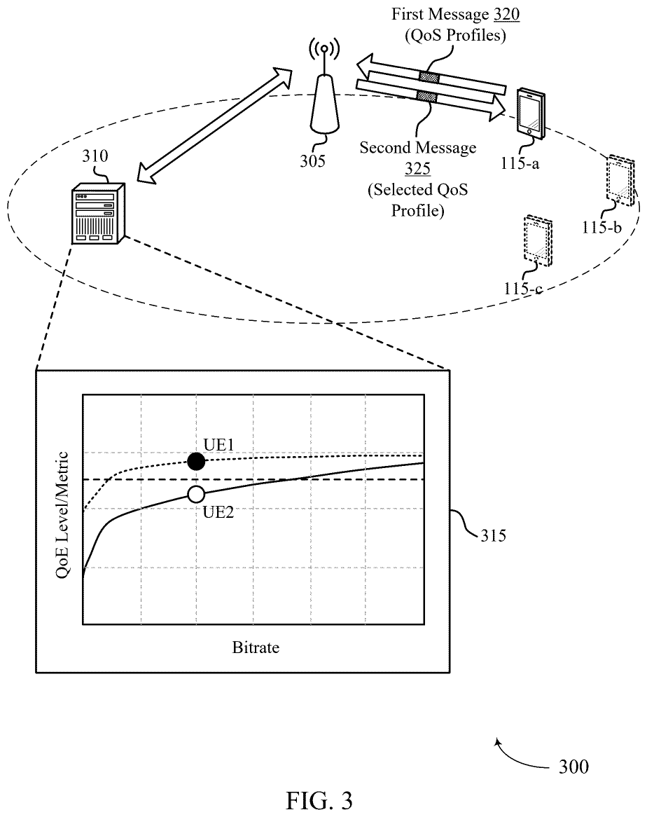

FIG. 3 shows an example of a wireless communications system 300 that supports QoS profiles for UX awareness in accordance with one or more aspects of the present disclosure. Aspects of the wireless communications system 300 may implement, or be implemented by, aspects of the wireless communications system 100, the network architecture 200, or both. For example, the wireless communications system 300 illustrates communication between network devices (such as a RAN node 305 and an application server 310, each of which may be examples of network entities 105 described with reference to FIG. 1, or other network nodes described with reference to FIG. 1), and UEs 115-a, 115-b, 115-c, each of which may be examples of UEs 115 described with reference to FIG. 1.

The wireless communications system 300 may support advanced technologies to enable implementation of a cyber-physical network or integrated cyber-physical world, which merges both physical and digital realities. For example, the wireless communications system 300 may support immersive applications such as immersive holographic telepresence with XR, VR, AR, mixed reality, interactive mapping, digital twin and virtual worlds, situational awareness, integration of artificial intelligence and artificial intelligence as a service (AIaaS), among other services. In some aspects, the application server 310 may facilitate or host such XR/VR applications that are executable by the UEs 115, where the RAN node 305 may be used to relay data associated with the XR/VR applications between the UEs 115 and the application server 310. In some aspects, immersive applications may utilize high reliability latency-bound (e.g., real-time) video streams with little to no buffering, and high data rates. For such applications and other advanced technologies, it is important to maintaining acceptable levels of user experience and QoE, for example, maintaining user experience and QoE at or above a quality threshold.

Adaptive rate control (e.g., adaptive bitrate (ABR) control) is an important feature in multimedia applications, such as XR applications. Current adaptive rate control mechanisms depend on end-to-end feedback (e.g., feedback between the UEs 115 and the application server 310), which typically happens on a slow timescale, and does not take QoE into consideration. Such mechanisms may result in large asymmetry in QoE among multiple UEs 115. For example, UEs 115 that are executing applications with simple scene content may consume the same data rate (e.g., bitrate) as compared to UEs 115 with more complex scene content, which may overtake radio resources without actual improvement of UX. By way of another example, UEs 115 in good channel conditions may end up selecting high bitrates (e.g., unnecessary high QoE), which may cause UEs 115 in worse channel conditions to have very low bitrates (e.g., low QoE). In some cases, over-the-top ABR algorithms may limit the bitrate in order not to exceed a certain quality, hence, freeing up network resources. Additionally, due to the new development of codecs, some new applications (e.g., new XR/VR applications) may operate at different bitrates and/or different error rate levels, which may be contrasted with the traditional guaranteed bitrate (GBR) vs. non-GBR QoS models.

Stated differently, different UEs 115 (and/or same UE 115 at different times) may have different QoE-bitrate curves due to different inputs or applications executable at the UE 115 (e.g., different scenes, movements, etc.). Therefore, because different bitrates may result in different UX metrics, exiting QoS parameters may not be sufficient to maintain acceptable UX levels across UEs 115. That is, in some cases, the wireless communications system 300 may utilize measurements of data rate and latency, among other quality-based measurement frameworks, in order to evaluate QoE for various applications. In some cases, however, measurements of data rate and latency (among other metrics) may be inadequate to fully evaluate QoE for UEs 115 running different applications. That is, evaluations of some QoE-based metrics may be inadequate to maintain acceptable QoE due to frequent channel variation and network loading conditions. Additionally, or alternatively, some systems may implement frameworks where multimedia systems are designed separately with specific assumptions on communications channels, which may limit integration between computation and media delivery. For example, the application server 310 generating video or streaming traffic may be configured separate from the communications of a wireless network (and may have limited knowledge of the operation of the wireless network), and conversely, the wireless network may be configured separately from the application server 310 generating the video traffic, and thus may have limited knowledge regarding the content of the traffic.

Taken together, the current framework for allocating bitrates to UEs 115 may result in varying QoE/UX among different UEs 115. In particular, allocating the same bitrate to all UEs 115 (even UEs 115 executing the same application) may not be sufficient to maintain an acceptable UX/QoE levels at the UEs 115. These issues are further shown and described with respect to the UX plot 315 shown in FIG. 3. The UX plot 315 illustrates QoE levels/metrics (e.g., peak signal-to-noise ratio (PSNR), SNR, or another quality metric) versus bitrate supplied by the application server 310 for different UEs 115 (e.g., UE1, UE2). As noted previously herein, the term “QoE level” may refer to a single metric (or a set of metrics) that quantifies the relative QoE/UX that is experienced or observed at a UE. That is, in some cases, a “QoE level” may include a single QoE metric (such as data rate), whereas in other cases, a “QoE level” may be determined based on a combination of multiple QoE metrics. In this regard, a first QoE level may be said to be “higher” or “better” than a second QoE level if at least one metric (e.g., data rate, service quality, latency) associated with the first QoE level exhibits a relatively higher UX as compared to a corresponding metric associated with the second QoE level. For instance, the first QoE level may be said to be “higher” or “better” than the second QoE level if the first QoE level is associated with a higher data rate and/or a lower latency at the UE as compared to the second QoE level.

As shown in the UX plot 315, the QoE level/metric (e.g., UX) for each UE 115 may flatten or saturate as supplied bitrate increases, that is, QoE/UX may increase greatly (e.g., by several units of PSNR) for an initially supplied bitrate, but may level off and increase more gradually or flatten as higher bitrates are supplied. In such cases, poor resource distribution among users (based on source unawareness of link conditions and link loading along with QoE unawareness at the RAN node 305) may result in substantial gaps in bitrate assignments to UEs 115 experiencing asymmetric channel conditions.

For example, a first user (e.g., UE1, which may be an example of a first UE 115-a) may be assigned excess bitrate (e.g., bitrate that is more than sufficient to obtain a threshold QoE), while the same bitrate supplied to a second user (e.g., UE2, which may be an example of a second UE 115-b) may not be sufficient to maintain the same threshold QoE. Poor resource allocation among users may therefore cause inefficiencies in resource distribution while also reducing the QoE for some users within the system. For example, the additional bitrate allocated for the first user (UE1) may be re-allocated to the second user (UE2), which may result in a significant increase in QoE/UX for the second user, while still maintaining a similar UX for the first user.

The issues with conventional techniques for supplying bitrates to UEs 115 may be a result of the rate-based key performance indicators (KPIs) used in some wireless communications systems, such as 4G and 5G systems. For example, some wireless communications systems may use a GBR scheme for low-latency applications. However, such GBR schemes may not be scalable to large quantities of UEs 115, may result in poor resource utilization due to cell-edge users, and may be expensive for operators (due to the fact that some UEs 115 may be provided excessive bitrates that are “overkill” for achieving some threshold QoE). Comparatively, other wireless systems may implement adaptive rate allocation schemes (e.g., via L4S), where the network provides fluctuating data rates and UX. However, such schemes may be difficult to monetize, as there is no guarantee for QoE/UX levels, and rate allocation may not take UX into account.

In other words, neither current GBR schemes nor adaptive rate allocation schemes directly take QoE/UX at the UEs 115 into account when allocating bitrates to the UEs 115. That is, with GBR schemes, the network may provide the same GBR (e.g., 5 Mbps) to every UE 115 in the network, and may be unaware of the impact that the resource allocation has on QoE/UX at the respective UEs 115. Moreover, this may lead to inefficient resource allocation that wastes network capacity, and leads to poor UX. For example, depending on the content and channel conditions across the UEs 115, the same 5 Mbps may result in a high QoE/UX at the first UE 115-a (e.g., UE1), but may lead to low QoE/UX at the second UE 115-b (e.g., UE2). In particular, complex scene content at the second UE 115-b (e.g., UE2) may require more resources (e.g., higher bitrate) to satisfy a threshold QoE/UX.

Comparatively, these problems with GBR schemes may be at least partially addressed in cases where the network (such as a 6G network) is aware of the resource allocation impact to QoE/UX. For example, in the example above, a total bitrate of 10 Mbps may be provided to two different UEs 115 (e.g., 5 Mbps to the two different UEs 115). However, if the network is aware of the impact that the respective bitrates have on the QoE/UX at each respective UE 115, the bitrates may be more efficiently allocated across UEs 115 to maintain the threshold QoE/UX, while simultaneously supporting larger quantities of UEs 115. For instance, the same total bitrate of 10 Mbps may be allocated across three different UEs 115 (e.g., UE146 Mbps, UE241 Mbps, UE343 Mbps), where UEs 115 with more complex content (e.g., UE1) can be allocated higher bitrates to achieve a threshold QoE/UX, and where UEs 115 with less complex content (e.g., UE2, UE3) may be allocated lower bitrates to achieve the same threshold QoE/UX. Thus, techniques described herein for network-aware QoE/UX impact may lead to a more efficient use of resources, improved QoE/UX, and higher capacity (e.g., more supported users).

To summarize, issues with conventional techniques for allocating bitrates across UEs 115 may be broken down into several observations/characteristics. First, UX as a function of bitrate (as shown in the UX plot 315) may be different for different users, and may depend on scene content and codec. That is, stored videos (e.g., AR/VR applications) may be encoded with different modes/profiles, and may exhibit various scene complexity and codecs. Second, QoE/UX flattens/saturates as bitrate increases (as shown in flattening curves with higher bitrates in the UX plot 315). Third, scene content can vary over time (even at the same UE 115), and so the QoE/UX-to-bitrate function may also vary over time. That is, the QoE-to-bitrate curve for UE1 may change over time as the scene content for an AR/VR application at UE1 changes over time. Fourth, UX-unaware rate allocation mechanisms in some networks (e.g., 5G networks) may not be able to guarantee a minimum QoE/UX threshold across users, and the number of simultaneous users meeting a UX threshold (capacity) may not be maximized.

Accordingly, aspects of the present disclosure are directed to RAN-assisted QoE/UX-aware bitrate selection, where the application server 310 may provide QoE-related information to the RAN in order to select QoS profiles that are tailored for communication with respective UEs 115. With QoE information available to the RAN (e.g., RAN node 305), QoS profile and bitrate selections may be updated to provide more symmetry in QoE/UX of different UEs 115. In particular, it has been found that aspects of the present disclosure may result in ~87% increase in QoE capacity within a network, where 90% of UEs 115 within a given network/cell may meet target QoE/UX metrics.

To support enhanced QoE and increased overall user experience for immersive applications and other advanced technologies for users, the wireless communications system 300 may support efficient resource allocation to increase the QoE for users with poor channel conditions, while maintaining the QoE for other users with good channel conditions. For example, the wireless communications system 300 may support granular coordination between the RAN node 305, the application server 310, the UEs 115, and other network components, to more effectively allocate resources and support improved QoE for multi-user systems.

In some aspects, the wireless communications system 300 may support increased application awareness at the RAN node 305 to enable RAN-assisted QoE-based source bitrate selection (e.g., QoS profile selection). For example, increased application awareness may include packet data unit (PDU) set awareness, including RAN-level awareness of one or more PDUs carrying a payload of one unit of information generated at an application level (e.g., video frame(s), video slice(s), etc. for extended reality services). Additionally, or alternatively, increased RAN-level awareness of application level functionality may include time-sensitive communication assistance information (TSCAI) enhancements to shift burst traffic timing adjustment, data rate adaptation, and framerate.

At a high level, as described herein, the wireless communications system 300 may support various signaling and configurations that enables QoE-aware selection of QoS profiles, as illustrated by the following steps described herein: (1) the application server 310 sends related QoE metrics (or UX metrics) in QoS profiles (e.g., QoS profiles include mapping points between bitrates and QoE/UX at the UE 115-a), (2) the RAN node 305 selects one of QoS profiles by considering the QoE metric(s), (3) the RAN node 305 (or another network node/entity) sends back the selected QoS profile to the application server 310, (5) the application server 310 adjusts the data rate used to communicate data to the UE 115-a according to the selected QoS profile, and (6) the application server 310 continues to update the QoS profiles (such as based on reported/measured QoE at the UE 115-d). Each of these steps will be discussed in turn.

For example, referring to FIG. 2, the application server 310 may output, to the RAN node 305, a first message 320 indicating one or more QoS profiles for operations at the UE 115-a (e.g., QoS profiles for AR/VR/XR operations at the UE 115-a). In some aspects, the QoS profiles may each include or indicate respective a bitrate corresponding to a respective QoE level for operations at the UE 115-a. That is, the first message 320 may indicate QoE information (e.g., video complexity information, streaming information, video content in real time) for each of the respective QoS profiles. For example, a first QoS profile may include or indicate a first bitrate that may be used to achieve a first QoE level at the UE 115-a, and a second QoS profile may include or indicate a second bitrate that may be used to achieve a second QoE level at the UE 115-a.

In this regard, aspects of the present disclosure may enable application function sessions with a preferred or required QoS for UX awareness by indicating QoE information along with QoS profiles. For example, the first message 320 may indicate one or more QoE-bitrate curves (e.g., N-bit quantization) associated with each QoS profile, where each QoE-bitrate curve indicates multiple bitrates and corresponding QoE metrics for the operations at the UE, as shown in the bitrate-QoE curves in the UX plot 315. Stated differently, different points along the bitrate-QoE curve for UE1 in the UX plot 315 may include or indicate different QoS profiles for UE1. For video flow, the application server 310 may provide the related video quality (e.g., PSNR or video multi-method assessment fusion (VMAF)) as the QoE level/metric according to the required bitrate for the respective QoS profile.

The respective QoE levels of the respective QoS profiles may be indicated as minimum target QoE levels, ranges of QoE values, or both. In other words, bitrates associated with the respective QoS profiles (e.g., GFBR, MFBR, maximum data burst volume (MDBV)) may be reinterpreted as the “required” bitrate to achieve the corresponding QoE level for the respective QoS profile.

In some cases, the first message 320 may include an application function session with QoS (AFSessionWithQoS) message (e.g., Nnef_AFSessionWithQoS message). In some examples, the first message 320 (e.g., AFSessionWithQoS message) may be used by the application server 310/application function to request that a data session with a UE 115 be set up with a specific QoS (e.g. low latency or packet delay variation (PDV)) and priority handling. That is, the first message 310 may be used by the application server 310/application function to provide multiple QoS profiles with QoE information to the network. In this regard, in accordance with some aspects of the present disclosure, the application server 310 may add QoE information for each of alternative service requirements in “AF Session with Required QoS” messages from the application server 310 (e.g., application function) to the NEF. Such QoE information may be included within a new information element (IE) for QoE information within a Nnef_AFSessionWithQoS message, such as application function with QoS-create (AFSessionWithQoS-Create) and/or application function with QoS-update (AFSessionWithQoS-Update) messages (e.g., Nnef_AFsessionWithQoS_Create request, Nnef_AFSessionWithQoS_Update request). In this regard, AFSessionWithQoS-Create and AFSessionWithQoS-Update messages may include examples of the first message 320. In some examples, the AFSessionWithQoS-Create message may be used to request the network to provide a specific QoS for an application function session (e.g., data session) for a UE 115 (or a list of UEs 115). Similarly, the AFSessionWithQoS-Update message may be used to request the network to update the parameters for an application function session (e.g., data session) for a UE 115 (or a lists of UEs 115).

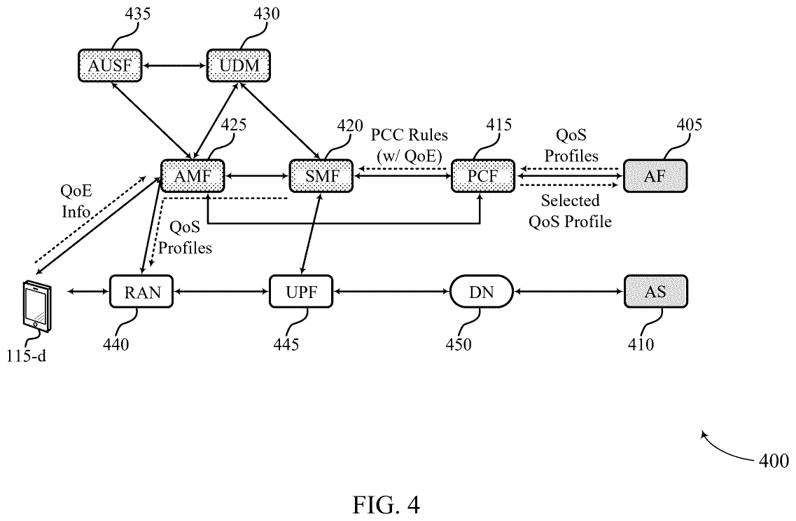

In additional or alternative cases, the first message 320 may include a PDU set metadata indicative of data traffic at the UE 115-a. That is, in some implementations, the application server 310 may indicate the QoS profiles (with bitrate-QoE information) in one or more messages that include PDU set metadata. For example, each PDU set may include metadata that includes information related to the PDU set (e.g., related to PDUs belonging to the PDU set). The PDU set metadata may indicate a number (e.g., quantity) of PDUs in a PDU set, a PDU set sequence number that identifies the PDU set, a PDU sequence number that identifies a PDU within the PDU set, a PDU set burst number, a PDU set discard time, or the like, among other examples. In some cases, PDU set metadata may include fields that define rules for determining the delivery status of a PDU set. For example, the PDU set metadata may define the number, ratio, or percentage of PDUs in a PDU set to be received for successful PDU set delivery. In some examples, the application server 310 may include the QoS profiles in the PDU set metadata (e.g., information for the QoS profiles may be multiplexed or piggybacked with the PDU set metadata, or may be included in one or more fields of the PDU set metadata). In some such examples, a service layer in a UPF may receive the PDU set metadata from the application server 310, and may signal or forward the PDCU set metadata (including the QoS profiles) to the RAN node 305, the UE 115-a, or both. In some other implementations, the application server 310 may forward the QoS profiles to a session management function (e.g., through a network exposure function (NEF)), which forwards the QoS profiles to the RAN node 305, as is further shown and described in FIG. 4.

The respective QoE levels of the QoS profiles may be associated with corresponding QoS IDs in accordance with one or more PCC configurations. Further, the respective QoS profiles may correspond to one or more service data flows (SDFs) based on the respective QoE levels of the QoS profiles. This is further shown and described with respect to FIG. 4.

In some aspects, the first message 320 may indicate prioritization metrics corresponding to the set of QoS profiles. That is, the first message 320 may indicate relative preferences or priorities for the respective QoS profiles (e.g., a first or “preferred” QoS profile, a second “preferred” QoS profile, etc.). Stated differently, the application server 310 may provide multiple QoS profiles (e.g., multiple points along the QoE-bitrate curve) in a preferred order, where the first QoS profile provides a “preferred” QoE, etc. Additionally, or alternatively, the application server 310 may simply indicate preferred QoE levels corresponding to respective QoS profiles.

In some cases, the first message 320 may indicate a time window/duration (e.g., QoS profile duration, QoS profile validity period) over which the respective bitrates and corresponding QoE levels associated with the QoS profiles are expected to be maintained at the UE 115-a (e.g., time window during which the provided QB-bitrate curve is expected to be maintained). The time window/duration may be indicated as an average time duration, a maximum duration, etc. (and/or may be re-interpreted by the RAN node 305). In particular, as noted previously herein, the QoE levels achievable for a given bitrate may change at the UE 115-a based on characteristics/parameters of the services at the UE 115-a, such as due to changes in video content complexity, XR content complexity, VR content complexity, mixed reality content complexity, changes in streaming content, or any combination thereof. In this regard, the first message 320 may indicate a time duration (e.g., next N frames or time segments, where N is one or more) that a respective bitrate and corresponding QoE level of a QoS profile is expected to be maintained (e.g., the QoE level for the first QoS profile is expected to be maintained or otherwise valid for X ms).

In some cases, the application server 310 may indicate a “default” QoS profile (e.g., default QoE-bitrate curve, which may include some ±delta and/or corresponding time window) that is to be used as a “fallback” QoS profile in cases where there are no other “valid” or usable QoS profiles for the UE 115-a.

The RAN node 305 may select a QoS profile to be used for communications between the UE 115-a and the application server 310. In particular, the RAN node 305 may select a QoS profile from the set of QoS profiles indicated by the application server 310 via the first message 320. In some aspects, the RAN node 305 may select the QoS profile based on the bitrates and QoE levels associated with the respective QoS profiles. That is, the network node 505 may select a QoS profile to be used to meet the respective QoE level at the UE 115.

In some cases, the RAN node 305 may select the QoS profile based on network conditions, such as channel conditions between the UE 115-a and the RAN node 305, network congestion (e.g., how many UEs 115 are in the network, or otherwise communicating with the RAN node 305), etc. Moreover, the RAN node 305 may select the QoS profile based on the prioritization metrics for the respective QoS profiles indicated by the application server 310 via the first message 320. That is, the RAN node 305 may attempt to select the QoS profile with the highest possible prioritization metric, to the extent possible based on network congestion, etc.

In some implementations, the RAN node 305 may select the QoS profile to be used for communications between the UE 115-a and the application server 310 to increase the QoE capacity of the wireless communications system (e.g., the total quantity of UEs 115 that meet the threshold QoE) and improve individual QoE for UEs 115 in the wireless communications system 300. In this regard, including QoE information within the QoS profiles may enable the RAN node 305 to more effectively and efficiently allocate resources (e.g., bitrates) to UEs 115, and to maximize the total quantity of UEs 115 that satisfy corresponding QoE thresholds. For example, if the threshold or target QoE is associated with a first metric (such as 36 dB PSNR), the application server 310 may identify a corresponding bitrate (e.g., 10 Mbps bitrate) that is required to maintain the threshold QoE, and may provide the bitrate information to the RAN node 305 via the QoE information included within the QoS profiles.

Stated differently, the RAN node 305 may calculate an enhanced (e.g., “optimal”) resource distribution (determined by selected QoS profiles) for the UEs 115 based on both the QoS profiles for the respective UEs 115 and the current link conditions experienced by the respective UEs 115. In some aspects, the enhanced (e.g., “optimal”) resource distribution may be a resource distribution among UEs 115 which allows for the total quantity of UEs 115 that meet or exceed the respective QoE thresholds to be increased or maximized. In some examples, the RAN node 305 may implement one or more enhancement (e.g., optimization) algorithms to select the QoS profiles that will achieve an enhanced (e.g., the “optimal”) resource distribution including supported bitrate values for the UEs 115. In such examples, the one or more optimization algorithms may include inputs which may include, but are not limited to, a minimum required bitrate to support respective threshold QoEs for respective UEs 115, and outputs which may include supported bitrate values for each of the respective UEs 115.

The RAN node 305 may output, to the application server 310, a second message 325 indicating the selected QoS profile. The second message 325 may include augmented QoS notification messages. In some aspects, the RAN node 305 may transmit the second message 325 (e.g., QoS notification message) to the application server 310 via other network nodes (e.g., the RAN may transmit the second message 325 to a core access and mobility management function (AMF), which forwards the QoS notification messages to a session management function (SMF), which forwards the QoS notification messages to a policy control function (PCF)), as is further shown and described with reference to FIG. 4. In some cases, the second message 325 may include a Nnef_AFsessionWithQoS_Notify message.

In some cases, the application server 310 may output, to the RAN node 305, a third message indicating an acknowledgment or confirmation of the selected QoS profile (e.g., an ACK responsive to the second message 325). That is, the third message may be used by the application server 310/application function that it will communicate with the selected QoS profile. In some cases, the third message may re-use an AFSessionWithQoS-response message, such as a Nnef_AFsessionWithQoS_Create message, a Nnef_AFSessionWithQoS_Update message, or both. Additionally, or alternatively, a new AFSessionWithQoS message can be introduced for this purpose.

Subsequently, the application server 310 and the UE 115-a may communicate data with one another (via the RAN node 305) in accordance with the selected/indicated QoS profile. The application server 310 may adapt an encoding bitrate to match the selected bitrate value associated with the QoS profile indicated by the RAN node 305. That is, the RAN node 305 may relay application data (e.g., AR/VR/XR data) between the UE 115-a and the application server 310. In this regard, the application server 310 may transmit application data (e.g., AR/VR/XR data) to the UE 115-a in accordance with the bitrate associated with the indicated QoS profile, where the bitrate is associated with a corresponding QoE level (e.g., UX) associated with the QoS profile.

In some cases, the RAN node 305 may determine QoE/UX metrics associated with communications with the UE 115-a. The RAN node 305 may determine the QoE/UX metrics at the UE 115-a by monitoring communications exchanged between the RAN node 305 and the UE 115-a. In other cases, the UE 115-a may provide QoE information to the RAN node 305 via a QoE report (which may be requested by the RAN node 305).

In some cases, the RAN node 305 may be configured to determine (and/or the UE 115-a may be configured to report) the QoE/UX metrics at the UE 115-a at regular (or irregular) intervals/periodicities, and/or in response to requests from the application server 310. In some cases, the periodicity at which the UE 115-a reports the QoE/UX metrics (and/or the periodicity at which the RAN node 305 determine/evaluate the QoE/UX metrics) may be based on a type of application/service at the UE 115-a (e.g., the type of application/service provided by the application server 310).

In some aspects, the RAN node 305 may output, to the application server 310, an indication of the QoE metrics/information at the UE 115-a. In some cases, the application server 310 may use the received QoE metrics/information to update the QOS profiles for applications at the UE 115-a. Moreover, the application server 310 may output, to the RAN node 305, an update to one or more QoS profiles. In some cases, the application server 310 may provide updated QoS profiles and corresponding bitrate-QoE information based on various factors such as dynamic changes in the complexity of video content or other streaming changes for the application, which may be observed/reported by the UE 115-a and/or RAN node 305. For example, RAN node 305 may report that a QoE level at the UE 115-a for a given bitrate/QoS profile has decreased. In this regard, the application server 310 may update the QoS profile with the newly-observed QoE level, and may transmit the updated QoS profile to the RAN node 305.

In some implementations, the application server 310 may be configured to update the QoS profiles with updated QoE-bitrate information using Nnef_AFSessionWithQoS_Update messages. In some cases, the update policy for updating the QoS profiles may be configured/indicated by the network and/or the application server 310. For example, QoS profiles may be updated based on (1) events (e.g., scene updates, bitrate or PSNR change thresholds, etc.), and/or (2) a defined periodicity (e.g., after an expiration of a time duration (e.g., ms), after a certain quantity of frames).

Stated differently, the RAN node 305 and/or the application server 310 may define or otherwise indicate one or more criteria for updating the QoS profiles. For example, the RAN node 305 may request that the QoS profiles be updated based on a periodicity (e.g., updates to the QoS profiles are sent by the application server 310 after each N frames, or after passage of a threshold duration of time such as N milliseconds). Additionally, or alternatively, the RAN node 305 and/or the application server 310 may request that the QoS profiles are updated after one or more events occur. For example, the RAN node 305 may identify a PSNR to bitrate change percentage (e.g., a QoE change) that exceeds a threshold change percentage, a change to video complexity, or a video scene change, or any combination thereof, and may transmit a request to the application server 310 to provide updated QoS profile information. In this regard, the application server 310 may update QoS profiles when certain trigger conditions (e.g., QoE-based trigger conditions) are satisfied.

In some aspects, the respective steps/functions described herein may be repeated based on the updated QoS profile(s). That is, upon receiving the updated QoS profile(s) from the application server 310, the RAN node 305 may select a QoS profile, transmit an indication of the selected QoS profile back to the application server 310, etc.

The implementation of QoE-aware QoS profile selection may allow for increased network coordination and more efficient selection of bitrates for multi-user systems. Additionally, or alternatively, the QoE-aware QoS profile selection may allow for relatively more UEs 115 to meet or exceed their respective QoE targets/levels. In addition, the QoE-aware QoS profile selection techniques described herein may allow for an increased amount of information available to the RAN node 305, which may allow for improved adaptation to video content, dynamic changes occurring for the video content, and dynamic resource allocation based on different content delivered to different users.

FIG. 4 shows an example of a wireless communications system 400 that supports QoS profiles for UX awareness in accordance with one or more aspects of the present disclosure. Aspects of the wireless communications system 400 may implement, or be implemented by, aspects of the wireless communications system 100, the network architecture 200, the wireless communications system 300, or any combination thereof.

The wireless communications system 400 illustrated in FIG. 4 illustrates different nodes and wireless devices of a wireless communications system 300, such as the wireless communications system 300. For example, the wireless communications system 400 may include an application function 405, an application server 410, a PCF 415, an SMF 420, an AMF 425, a unified data management (UDM) 430, an authentication server function (AUSF) 435, a RAN 440, a UPF 445, a data network (DN) 450, and a UE 115-d, which may be examples of corresponding devices, nodes, and components described herein.

For example, the application function 405 and/or application server 410 shown and described in FIG. 4 may be examples of the application server 310 shown and described in FIG. 3. For the purposes of the present disclosure, the application function 405 may refer to, include, or represent the interface between the wireless network (e.g., 5G/6G network) and the application server 410. In this regard, any steps, signaling, or functions described as being performed by the application function 405 may additionally or alternatively be understood to be performed by the application server 410. Similarly, the PCF 415, the SMF 420, the AMF 425, the UDM 430, the AUSF 435, the RAN 440, the UPF 445, the DN 450, or any combination thereof, may be examples of the RAN node 305 shown and described in FIG. 3, and may therefore be generally referred to as “network nodes.”

At a high level, as described herein, the wireless communications system 400 may support various signaling and configurations that enables QoE-aware selection of QoS profiles, as illustrated by the following steps described herein: (1) the application server 410 sends related QoE metrics (or UX metrics) in QoS profiles (e.g., QoS profiles include mapping points between bitrates and QoE/UX at the UE 115-d), (2) RAN 440 (or another network node/entity) selects one of QoS profiles by considering the QoE metric(s), (3) the RAN 440 (or another network node/entity) sends back the selected QoS profile to the application server 410, (5) the application server 410 adjusts the data rate used to communicate data to the UE 115-d according to the selected QoS profile, and (6) the application server 410 continues to update the QoS profiles (such as based on reported/measured QoE at the UE 115-d). Each of these steps will be discussed in turn.

In some conventional systems, in order to facilitate communications/applications with the UE 115-d (e.g., AR/VR/XR applications), the application function 405 and/or application server 410 may request an application function session with a required QoS via AF/NEF signaling, such as via a Nnef_AFSessionWithQoS message that is transmitted from the application function 405 to the PCF 415. The Nnef_AFSessionWithQoS message may indicate one or more alternative service requirements, such as QoS reference parameters, and/or requested alternative QoS parameter sets, which may be provided or otherwise indicated in a prioritized order. That is, in some aspects, the server (e.g., application function 405, application server 410) may request multiple sets of alternative QoS parameters in a prioritized order. Requested QoS parameters may be requested for respective time periods and/or traffic volumes. Moreover, the request may be based on additional parameters or characteristics, such as QoS monitoring parameters (e.g., packet delay, congestion), reporting frequency, target of reporting, TSCAI parameters (e.g., flow direction, burst arrival time (BAT), BAT window, periodicity, periodicity range), round-trip latency information, multi-modality, explicit congestion notification (ECN) marking indication for L4S, and the like.

Continuing with reference to FIG. 4, upon receiving a request for an AF session with a required/requested QoS, the SMF 420 may provide a list of multiple alternative QoS profiles to the RAN 440 for a specific QoS flow. QoS parameters of a QoS profile/flow may include, but are not limited to, a resource type, priority level, a packet delay budget (PDB), packet error rate (PER), averaging window, guaranteed flow bitrate (GFBR), maximum flow bitrate (MFBR), and maximum data burst volume (MDBV). The RAN 440 may be configured to select one of the alternative QoS profiles which can be fulfilled and used to facilitate communications between the UE 115-d and the application function 405/application server 410.

However, as noted previously herein, in some conventional networks, the respective network nodes of the wireless communications system 400 may not know the impact to the UE 115-d for each of the alternative QoS profiles. In other words, the network nodes may not know how a selected QoS profile may affect the QoE/UX at the UE 115-d.

Accordingly, aspects of the present disclosure are directed to RAN-assisted QoE-aware source bitrate selection to provide high quality services across UEs 115. In particular, aspects of the present disclosure are directed to signaling and configurations that are used to communicate QoS profiles with QoE/UX information for respective UEs 115 such that QoS profiles may be selected to achieve known QoE/UX metrics at respective UEs 115.

For example, as described with respect to FIG. 3, the application function 405 and/or application server 410 may output, to the PCF 415, a first message indicating one or more QoS profiles for operations at the UE 115-a (e.g., QoS profiles for AR/VR/XR operations at the UE 115-a). In some aspects, the QoS profiles may each include or indicate respective bitrate corresponding to a respective QoE level for operations at the UE 115-d. In other words, the application function 405/application server 410 may add QoE information for each of alternative service requirements in ‘AF Session with Required QoS’ (AF to NEF) via a new information element within Nnef_AFSessionWithQoS messages that are transmitted to the PCF 415. Moreover, the application function 405 and/or application server 410 may update the QoS profiles based on identified events (e.g., scene updates, bitrate or PSNR change thresholds), and/or according to some defined periodicity (e.g., update every X msec or Y number of frames).

Further, the QoS profiles with QoE information (as described herein) may be added to the signaling in the network interface between the NEF and PCF 415 (e.g., “NEF to PCF”). In other words, the QoS profiles with QoE information may be added to network interface signals between NEF and PCF 415 (e.g., Npcf_PolicyAuthorization messages). Similarly, QoS profiles with QoE information may be added or communicated via the network interface between the PCF 415 and the SMF 420.

In some aspects, the PCF 415 may be configured to generate PCC rules, and corresponding SMF 420 operation based on the PCC rules (e.g., PCF-generation of the PCC rules, and corresponding SMF operation based). In this regard, the respective QoE levels of the QoS profiles may be associated with corresponding QoS IDs in accordance with one or more PCC configurations. That is, the PCF 415 may be configured to define the target QoE in QoS profiles/parameters (e.g., define PCC rules), where the network (e.g., network nodes, application server 410) attempts to meet the target QoE for a specific QoS profile/flow (e.g., define the target QoE in 6G QoS parameters via a PCC rule).

For example, in accordance with a first implementation, a PCC rule defined by the PCF 415 may define the QoE-driven QoS flow (e.g., dynamic PCC rule), where the PCF 415 may indicate such one or more dynamic PCC rules to the SMF 420. In such cases, according to an SDF template (e.g., 5-tuple-IP address, port), a specific service flow can work with QoE, and a unified data repository (UDR) can provide the QoE requirement to the PCF 415.

By way of another example, in accordance with a second implementation, the SMF 420 and/or UPF 445 may have/store a predefined PCC rule with QoE requirement(s), where the predefined PCC rule can provide the target QoE for a specific QoS profile/flow. For instance, an XR service may be guaranteed to exhibit 26-32 dB PSNR video quality (QoE metric).

In some aspects, the SMF 420 may be configured to determine the final QoS profiles/parameters for the QoS flow that may be used to facilitate communications between the application function 405/application server 410 and the UE 115-d. Additionally, in some implementations, QoS flow binding (e.g., SDF binding) with QoE information may be performed at the SMF 420. In other words, the SMF 420 may perform QoS flow mapping to meet PCC rules (which may be defined/signaled by the PCF 415). In some aspects, each QoS flow may be associated with (e.g., include) a QoS profile. As described herein, each QoS profile may include a set of QoS parameters within the QoS flow (including QoE-bitrate information) which specifies the quality of service, such as 5QI, GFBR, MFBR etc. SMF can bind multiple SDFs into a single QoS flow if the SDFs have the same QoS profile. The SMF 420 may be configured to consider the QoE parameters (e.g., QoE levels of the QoS profiles) when performing QoS flow binding.

In other words, the SMF 420 may determine how to bind different SDFs to the same QoS flows, and whether the QoE aspect should be considered when deciding whether to bind to the same QoS flow or different QoS flow (e.g., separate SDFs that with QoE or traditional QoS profiles, or separate SDFs for time and/or location-based QoE/QoS profiles). For example, the SMF 420 may be configured to establish a separate QoS flow to guarantee the QoE requirement for a respective QoS profile. By way of another example, the SMF 420 may bind multiple SDFs which have the same QoE requirement (e.g., bind multiple SDFs with multiple QoS profiles that have the same/similar QoE levels). For instance, the SMF 420 may bind multiple SDFs for multiple slices of a video frame to the same QoS flow.

Continuing with reference to FIG. 4, the QoS profiles with QoE information (as described herein) may be added to the signaling for alternative QoS profiles between the SMF 420 and the RAN 440. In some aspects, such QoS profiles with QoE information may be indicated via a new IE for QoE information associated with alternative QoS profiles. As noted previously herein, required bitrates associated with QoS profiles may be reinterpreted as GFBR, MFBR, and/or MDBV that is used to achieve the corresponding QoE level at the UE 115-d for the respective QoS profile.

In some implementations, the RAN 440 may be configured to determine/select the QoS profile to be used for communications between the UE 115-d and the application function 405/application server 410. As described herein, the RAN 440 may select the QoS profile for the UE 115-d based on QoE levels/thresholds (and corresponding bitrates) across different UEs 115, network congestion (e.g., a quantity of UEs 115 connected to the RAN 440), etc. That is, the RAN 440 can select one of the candidate QoS profiles by considering the UX impacts (QoE) across multiple users. In the context of 5G networks, 5G QoS IDs (5QIs) may include relative priority information, which may be used for evaluating the QoE levels at the RAN 440, and may therefore be used to select QoS profiles.

In this regard, the RAN 440 may select one of the alternative QoS profiles for communications at the UE 115-d, and may send the feedback to the application function 405/application server 410. That is, the RAN 440 may indicate, to the application server 410, which QoS profile was selected for communications between the UE 115-d and the application server 410. In this regard, the PCF 415 may provide the response “AF session with Required QoS” to the application function 405/application server 410 with Nnef_AFsessionWithQoS_Notify, and the application function 405/application server 410 may respond with Nnef_AFsessionWithQoS_Create response, Nnef_AFSessionWithQoS_Update response and/or a new Nnef_AFSessionWithQoS message. In other cases, instead of the RAN 440, there may be another dedicated or centralized unit/entity within the network that may be configured to select QoS profiles (e.g., UX controller node).

In additional or alternative implementations, in the context of 6G networks, QoE metrics/thresholds associated with respective QoS profiles may be defined by 6G QoS IDs (6Qis). That is, 6Qis may define QoE parameters for respective QoS profiles. By defining QoE metrics via 6QIs, the explicit signaling of parameters may be reduced. For example, in some implementations, a new category of 6QIs may be introduced (e.g., QoE-controlled 6QIs) which may be different from GBR and non-GBR mechanisms. With this new type of 6QIs, each 6QI may include or otherwise be associated with QoE metrics (e.g., QoE-bitrate curves, similar to how GBR mechanisms must have GFBR/MFBR). In other cases, the QoE parameters may simply be added to existing current 5QI/6QI categories. Table 1 below illustrates an example of a standardized 6QI-to-QoS characteristic mapping for a single target QoE level, where Table 2 illustrates an example of a standardized 6QI-to-QoS characteristic mapping for a range of QoE levels:

TABLE 1
Standardized 6QI-to-QoS Characteristics Mapping for Single Target QoE

| | | Default | Packet | Packet | | Default | Default | |
|---|---|---|---|---|---|---|---|---|
| 6QI | Resource | Priority | Delay | Error | Default | Averaging | Min. | |
| Value | Type | Level | Budget | Rate | MDBV | Window | QoE | Example Services |
| 80 | | 68 | 10 ms | 10⁻⁶ | N/A | N/A | 26 dB | Low Latency |
| | | | | | | | | eMBB |
| | | | | | | | | applications; AR |

TABLE 2
Standardized 6QI-to-QoS Characteristics Mapping for QoE Range

| | | Default | Packet | Packet | | Default | Default | |
|---|---|---|---|---|---|---|---|---|
| 6QI | Resource | Priority | Delay | Error | Default | Averaging | QoE | |
| Value | Type | Level | Budget | Rate | MDBV | Window | Range | Example Services |
| 80 | | 68 | 10 ms | 10⁻⁶ | N/A | N/A | 26-32 dB | Low Latency |
| | | | | | | | | eMBB |
| | | | | | | | | applications; AR |

As noted previously herein, there may be different options for defining target QoE levels/metrics for QoS profiles/parameters. In accordance with a first implementation, QoS profiles (e.g., QoS requirements) may provide a single minimum target QoE level/metric for the respective QoS profile. For the single target QoE level/metric, the network may be expected to try to meet the minimum QoE level/metric by communicating with the application server 410.

In accordance with a second implementation, QoS profiles may provide a range of QoE levels/metrics (e.g., minimum QoE level to maximum QoE level). The maximum QoE level/metric may set the upper-bound of QoE at the respective UE 115-d, where low-prioritized UEs 115 may be restricted by this boundary. Conversely, the minimum QoE level/metric may guarantee the lower-bound of QoE at the respective UE 115-d, so that low-prioritized UEs 115 may not be affected too much when high-prioritized UEs 115 are allocated high bitrates, thereby occupying large quantities of resources. For the range of QoE metrics between the maximum/minimum QoE levels, the network may be allowed/enabled to adjust the QoE (by adjusting the bitrate) within the range according to network congestion levels by communicating with the application server 410. This may allow flexibility for the RAN 440 to select bitrates/QoE levels within the range without notifying the application server 410. within this QoE range without notification. For dynamic traffic such as XR, the range of QoS/QoE metrics may relax the signaling overhead among the network nodes/entities.

As noted previously herein, the respective network nodes (e.g., PCF 415, RAN 440) may be configured to select the QoS profile to be used for communication between the UE 115-d and the application function 405/application server 410 based on the target QoE level/metric (e.g., QoE requirement/threshold) at the UE 115-d. For example, in accordance with a first implementation, the PCF 415 may filter the alternative QoS profiles that meet the QoE requirement/threshold at the UE 115-d. That is, the PCF 415 may filter/identify QoS profiles that are associated with a QoE level/metric that satisfies some QoE requirement/threshold at the UE 115-d. In accordance with a second implementation, the PCF 415 may provide the QoE requirement/threshold for a specific QoS profile/flow to other entity (e.g., SMF 420, RAN 440) which selects one of the alternative QoS profiles that meet the QoE requirement/threshold. In some aspects, the RAN 440 may be configured to suggest alternative QoS profile(s) to the network and/or the application server 410. Further, the RAN 440 may be configured to determine the exact bitrate/range (and corresponding QoS profile) by itself, where the application server 410 may be configured to target the determined bitrate.

Target QoE metrics (e.g., QoE requirements/thresholds) may be used in conjunction with legacy QoS requirements (e.g., GFBR, MFBR and MDBV). For example, for a given service/operation at the UE 115-d, network may be required to meet all requirements including legacy QoS requirements and target QoE thresholds (e.g., satisfy GFBR, MFBR, MDBV, and QoE threshold). In other cases, QoE metrics/thresholds described herein ma overwrite (e.g., be used in lieu of) the legacy QoS requirements. In some aspects, a PCF 415 rule may be able to choose/indicate which of these options is to be used (e.g., whether QoE thresholds are to be used in addition to legacy QoS requirements, or in lieu of legacy QoS requirements).

In some implementations, the RAN 440 may keep updating the selected QoS profile (and/or continue to select new QoS profiles that are to be used) while waiting for the next update of QoS profiles from the application function 405/application server 410. Moreover, the RAN 440 may select new QoS profiles based on data traffic at other UEs 115 (e.g., select a new QoS profile if other UEs 115 requires additional resource/higher bitrates to guarantee a certain video quality). In some implementations, the RAN 440 may be configured to maintain the bitrate at the UE 115-d at a certain level until (1) the application function 405/application server 410 confirms the selected QoS profile (e.g., via communicating a confirm/ACK message), (2) after an expiration of some timer (e.g., ms), and/or (3) after a certain quantity of frames.

As noted previously herein, QoS profiles may be updated (and new QoS profiles may be selected) based on monitored QoE/QoS metrics. That is, QoS monitoring parameters may be used for QoE metrics and for updating QoS profiles. For example, QoS monitoring parameter(s) that can be measured by means of QoS monitoring may include uplink packet delay, downlink packet delay, round trip packet delay, congestion, data rate, and the like. These parameters for a QoS monitoring policy may be defined in a PCC rule. In some cases, QoE may be added to such QoS monitoring parameters. That is, the network may set up QoE monitoring for a certain QoS flow, where the RAN 440 and/or the UPF 445 may be expected to monitor the QoE (at the UE 115-d) of a certain QoS flow, and report it back to the network. Stated differently, in some implementations, the RAN 440 may be configured to monitor QoE experienced at the UE 115-d and report it back to the various network nodes and/or application function 405/application server 410, where the monitored/reported QoE information may be used to update QoS profiles and/or select new QoS profiles to be used for communications at the UE 115-d.

In some cases, the wireless communications system 400 may utilize different QoE monitoring mechanisms (current on-going frames). For example, in accordance with a first implementation, the application server 410 may provide the current QoE level/metric for a given QoS profile in PDU set metadata (e.g., RTP-HE), as described herein. In such cases, for downlink communications, the UPF 445 can extract the QoE information and provide it to any of the network nodes described herein (e.g., RAN 440, SMF 420). By way of another example, the RAN 440 may ask/request the UE 115-d to report QoE back to the network (via a QoE report with RVQoE, for RAN-visible QoE). In such cases, the UE 115-d may be configured to report measured/observed QoE (e.g., report current video quality, which may be reported per-frame or as an average over some time window) to the network, where such QoE information may be used to update QoS profiles for the UE 115-d and/or select new QoS profiles that to used for communications with the UE 115-d.

While much of the present disclosure has been described in the context of QoE for video flows (e.g., AR/VR/SR applications at the UE 115-d with video), aspects of the present disclosure may be used in the context of QoE/UX for other flows, such as video flows, audio flows, haptic flows, etc. Moreover, QoE/UX may be understood to include various parameters/aspects, such as service quality, power consumption, latency, and performance.

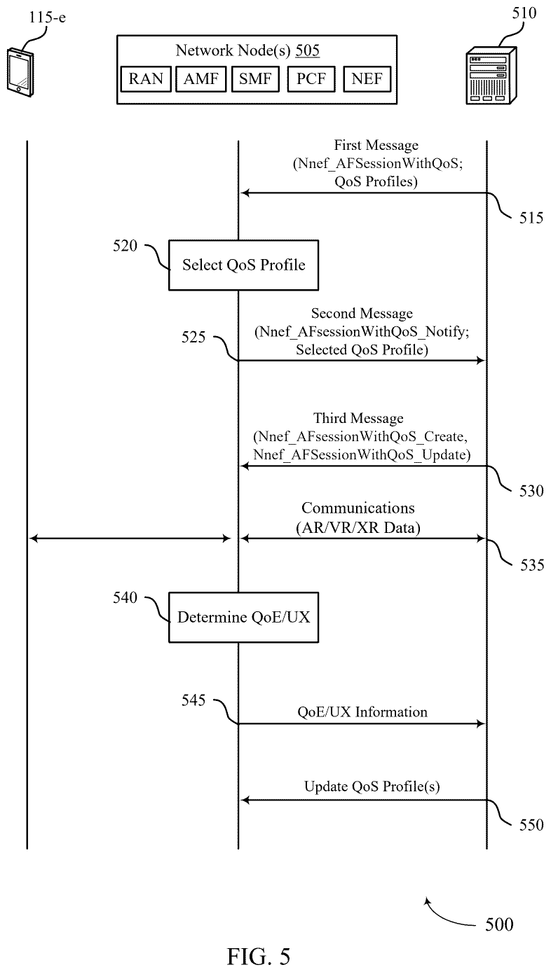

FIG. 5 shows an example of a process flow 500 that supports QoS profiles for UX awareness in accordance with one or more aspects of the present disclosure. Aspects of the process flow 500 may implement, or be implemented by, aspects of the wireless communications system 100, the network architecture 200, the wireless communications system 300, the wireless communications system 400 or any combination thereof.

For example, the process flow 500 may illustrate a communications flow or call flow between a UE 115-e, one or more network nodes 505, and an application server 510, which may be examples of the corresponding devices as described with reference to FIGS. 1-4. In this regard, the network nodes 505 shown and described in FIG. 5 may be examples of the RAN node 305 illustrated in FIG. 3 and/or the network nodes (e.g., PCF 415, SMF 420, AMF 425, UDM 430, AUSF 435, RAN 440, UPF 445, DN 450) illustrated in FIG. 4. Similarly, the application server 510 shown and described in FIG. 5 may be an example of the application server 310 illustrated in FIG. 3 and/or the application function 405/application server 410 illustrated in FIG. 4.

In the following description of the process flow 500, the operations between the UE 115-e, the network nodes 505, and the application server 510 may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time.

At signaling operation 515, the application server 510 may output, to the one or more network nodes 505, a first message indicating one or more QoS profiles for operations at the UE 115-e (e.g., QoS profiles for AR/VR/XR operations at the UE 115-e). In some cases, the first message may include an application function session with QoS message (e.g., Nnef_AFSessionWithQoS message). In additional or alternative cases, the first message may include a PDU set metadata indicative of data traffic at the UE.

In some aspects, the QoS profiles may each include or indicate respective bitrate corresponding to a respective QoE level for operations at the UE 115-e. For example, the first message may indicate one or more QoE-bitrate curves (as shown in the UX plot 315 in FIG. 3) associated with each QoS profile, where each QoE-bitrate curve indicates multiple bitrates and corresponding QoE metrics for the operations at the UE. The respective QoE levels of the respective QoS profiles may be indicated as minimum target QoE levels, ranges of QoE values, or both.

The respective QoE levels of the QoS profiles may be associated with corresponding QoS IDs in accordance with one or more PCC configurations. Further, the respective QoS profiles may correspond to one or more SDFs based on the respective QoE levels of the QoS profiles.

In some aspects, the first message may indicate prioritization metrics corresponding to the set of QoS profiles. That is, the first message may indicate relative preferences or priorities for the respective QoS profiles (e.g., a first or “preferred” QoS profile, a second “preferred” QoS profile, etc.).

In some cases, the first message may indicate a time duration over which the respective bitrates and corresponding QoE levels associated with the QoS profiles are expected to be maintained at the UE 115-e. In particular, as noted previously herein, the QoE levels achievable for a given bitrate may change at the UE 115-a based on characteristics/parameters of the services at the UE 115-e, such as due to changes in video content complexity, extended reality content complexity, VR content complexity, mixed reality content complexity, changes in streaming content, or any combination thereof. In this regard, the first message may indicate a time duration that a respective bitrate and corresponding QoE level of a QoS profile is expected to be maintained (e.g., the QoE level for the first QoS profile is expected to be maintained or otherwise valid for X ms).

At processing operation 520, the one or more network nodes 505 may select a QoS profile to be used for communications between the UE 115-e and the application server 510. In particular, the network nodes 505 may select a QoS profile from the set of QoS profiles indicated by the application server 510 via the first message. In some aspects, the network nodes 505 may select the QoS profile based on the bitrates and QoE levels associated with the respective QoS profiles. That is, the network node 505 may select a QoS profile to be used to meet the respective QoE level at the UE 115.

In some cases, the network nodes 505 may select the QoS profile based on network conditions, such as channel conditions between the UE 115-e and the network nodes 505, network congestion (e.g., how many UEs 115 are in the network, or otherwise communicating with the network nodes 505), etc. Moreover, the network nodes 505 may select the QoS profile based on the prioritization metrics for the respective QoS profiles indicated by the application server 510 via the first message. That is, the network nodes 505 may attempt to select the QoS profile with the highest possible prioritization metric, to the extent possible based on network congestion, etc.

At signaling operation 525, the one or more network nodes 505 may output, to the application server 510, a second message indicating the selected QoS profile. The network nodes 505 may output the second message based on obtaining the first message, selecting the QoS profile, or both. In some cases, the second message may include an application function session with QoS-response message, such as a Nnef_AFsessionWithQoS_Notify message.

At signaling operation 530, the application server 510 may output, to the network nodes 505, a third message indicating an acknowledgement or confirmation of the selected QoS profile. In some cases, the third message may include an application function session with QoS-response message, such as a Nnef_AFsessionWithQoS_Create message, a Nnef_AFSessionWithQoS_Update message, or both.

At signaling operation 535, the application server 510 and the UE 115-e may communicate data with one another (via the one or more network nodes 505) in accordance with the selected/indicated QoS profile. That is, the network nodes 505 may relay application data between the UE 115-e and the application server 510. In this regard, the application server 510 may transmit application data (e.g., AR/VR/XR data) to the UE 115-e in accordance with the bitrate associated with the indicated QoS profile, where the bitrate is associated with a corresponding QoE level (e.g., UX) associated with the QoS profile.

At processing operation 540, the network nodes 505 may determine QoE/UX metrics associated with communications with the UE 115-e. In some cases, the network nodes 505 may determine the QoE/UX metrics at the UE 115-e by monitoring communications exchanged between the network nodes 505 and the UE 115-e. In other cases, the UE 115-e may provide QoE information to the network nodes 505 via a QoE report (which may be requested by the network nodes 505).

In some cases, the network nodes 505 may be configured to determine (and/or the UE 115-e may be configured to report) the QoE/UX metrics at the UE 115-e at regular (or irregular) intervals/periodicities, and/or in response to requests from the application server 510. In some cases, the periodicity at which the UE 115-e reports the QoE/UX metrics (and/or the periodicity at which the network nodes 505 determine/evaluate the QoE/UX metrics) may be based on a type of application/service at the UE 115-e (e.g., the type of application/service provided by the application server 510).

At signaling operation 545, the network nodes 505 may output, to the application server 510, an indication of the QoE metrics/information at the UE 115-e. That is, the network nodes 505 may report the QoE metrics (e.g., UX information) that were determined at processing operation 540.

At signaling operation 550, the application server 510 may output, to the network nodes 505, an update to one or more QoS profiles. The application server 510 may update one or more QoS profiles at signaling operation 550 based on the QoE/UX information that was obtained from the network nodes 505 at signaling operation 545. For example, network nodes 505 may report that a QoE level at the UE 115-e for a given bitrate/QoS profile has decreased. In this regard, the application server 510 may update the QoS profile with the newly-observed QoE level, and may transmit the updated QoS profile to the network nodes 505.

In some aspects, the respective steps/functions shown and described in the process flow 500 may be repeated based on the updated QoS profile(s) at signaling operation 550. That is, in response to the updated QoS profile(s), the network nodes 505 may select a QoS profile (processing operation 520), transmit an indication of the selected QoS profile (signaling operation 525), etc.

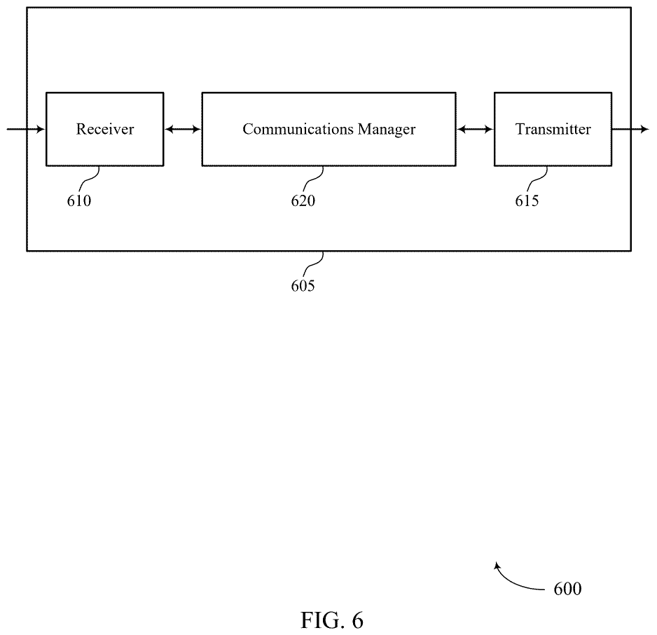

FIG. 6 shows a block diagram 600 of a device 605 that supports QoS profiles for UX awareness in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of QoS profiles for UX awareness as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for outputting, to one or more network nodes of a wireless communications system, a first message indicative of a set of multiple QoS profiles for operations at a UE, where the set of multiple QoS profiles each indicate a respective bitrate corresponding to a respective QoE level for operations at the UE. The communications manager 620 is capable of, configured to, or operable to support a means for obtaining a second message indicative of a QoS profile selected from the set of multiple QoS profiles, the QoS profile including a first bitrate configured to maintain a first QoE level at the UE. The communications manager 620 is capable of, configured to, or operable to support a means for communicating data with the UE via the one or more network nodes in accordance with the QoS profile indicated via the second message.

Additionally, or alternatively, the communications manager 620 may support wireless communications in accordance with examples as disclosed herein. For example, the communications manager 620 is capable of, configured to, or operable to support a means for obtaining, from an application server, a first message indicative of a set of multiple QoS profiles for operations at a UE, where the set of multiple QoS profiles each indicate a respective bitrate corresponding to a respective QoE level for operations at the UE. The communications manager 620 is capable of, configured to, or operable to support a means for outputting a second message indicative of a QoS profile selected from the set of multiple QoS profiles, the QoS profile including a first bitrate configured to maintain a first QoE level at the UE. The communications manager 620 is capable of, configured to, or operable to support a means for communicating data between the application server and the UE in accordance with the QoS profile indicated via the second message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for QoE/UX-aware QoS selection, which may enable reduced processing and distributed processing, more efficient utilization of communication resources, more effective coordination between network devices providing advanced applications.

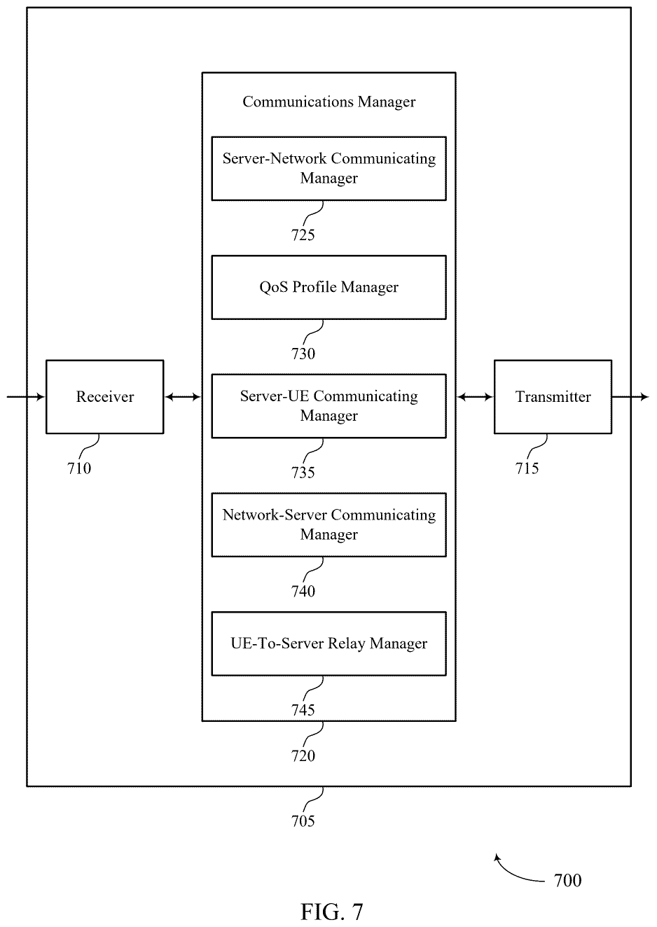

FIG. 7 shows a block diagram 700 of a device 705 that supports QoS profiles for UX awareness in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of QoS profiles for UX awareness as described herein. For example, the communications manager 720 may include a server-network communicating manager 725, a QoS profile manager 730, a server-UE communicating manager 735, a network-server communicating manager 740, a UE-to-server relay manager 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The server-network communicating manager 725 is capable of, configured to, or operable to support a means for outputting, to one or more network nodes of a wireless communications system, a first message indicative of a set of multiple QoS profiles for operations at a UE, where the set of multiple QoS profiles each indicate a respective bitrate corresponding to a respective QoE level for operations at the UE. The QoS profile manager 730 is capable of, configured to, or operable to support a means for obtaining a second message indicative of a QoS profile selected from the set of multiple QoS profiles, the QoS profile including a first bitrate configured to maintain a first QoE level at the UE. The server-UE communicating manager 735 is capable of, configured to, or operable to support a means for communicating data with the UE via the one or more network nodes in accordance with the QoS profile indicated via the second message.

Additionally, or alternatively, the communications manager 720 may support wireless communications in accordance with examples as disclosed herein. The network-server communicating manager 740 is capable of, configured to, or operable to support a means for obtaining, from an application server, a first message indicative of a set of multiple QoS profiles for operations at a UE, where the set of multiple QoS profiles each indicate a respective bitrate corresponding to a respective QoE level for operations at the UE. The QoS profile manager 730 is capable of, configured to, or operable to support a means for outputting a second message indicative of a QoS profile selected from the set of multiple QoS profiles, the QoS profile including a first bitrate configured to maintain a first QoE level at the UE. The UE-to-server relay manager 745 is capable of, configured to, or operable to support a means for communicating data between the application server and the UE in accordance with the QoS profile indicated via the second message.

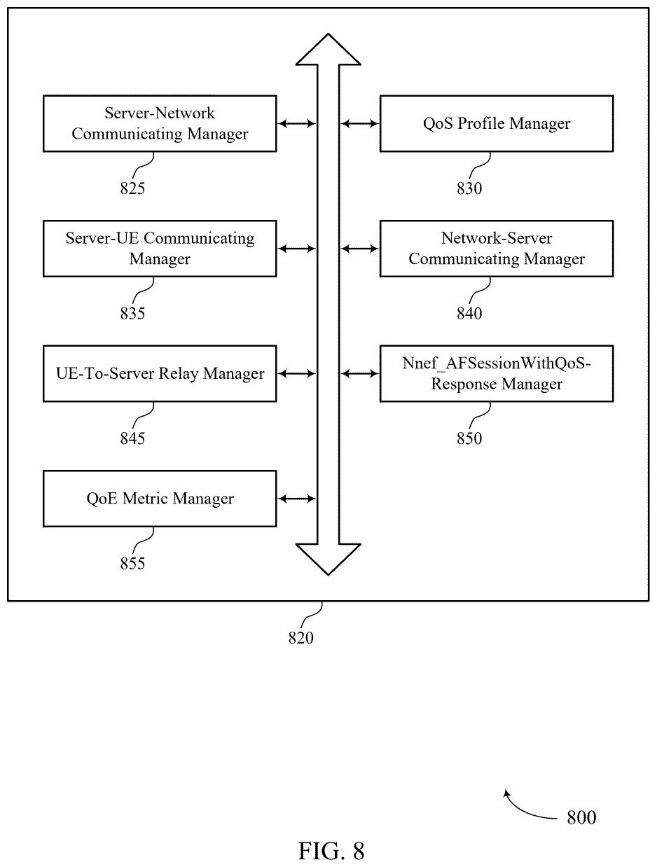

FIG. 8 shows a block diagram 800 of a communications manager 820 that supports QoS profiles for UX awareness in accordance with one or more aspects of the present disclosure. The communications manager 820 may be an example of aspects of a communications manager 620, a communications manager 720, or both, as described herein. The communications manager 820, or various components thereof, may be an example of means for performing various aspects of QoS profiles for UX awareness as described herein. For example, the communications manager 820 may include a server-network communicating manager 825, a QoS profile manager 830, a server-UE communicating manager 835, a network-server communicating manager 840, a UE-to-server relay manager 845, a Nnef_AFSessionWithQoS-Notify manager, a Nnef_AFSessionWithQoS-Response manager 850, a QoE metric manager 855, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The server-network communicating manager 825 is capable of, configured to, or operable to support a means for outputting, to one or more network nodes of a wireless communications system, a first message indicative of a set of multiple QoS profiles for operations at a UE, where the set of multiple QoS profiles each indicate a respective bitrate corresponding to a respective QoE level for operations at the UE. The QoS profile manager 830 is capable of, configured to, or operable to support a means for obtaining a second message indicative of a QoS profile selected from the set of multiple QoS profiles, the QoS profile including a first bitrate configured to maintain a first QoE level at the UE. The server-UE communicating manager 835 is capable of, configured to, or operable to support a means for communicating data with the UE via the one or more network nodes in accordance with the QoS profile indicated via the second message.

In some examples, the first message includes an application function session with QoS message (e.g., Nnef_AFSessionWithQoS). In some cases, the first message may include AFSessionWithQoS-Create and/or AFSessionWithQoS-Update messages (e.g., Nnef_AFsessionWithQoS_Create request, Nnef_AFSessionWithQoS_Update request), or both.

In some examples, the first message indicates a QoE-bitrate curve associated with the set of multiple QoS profiles, the QoE-bitrate curve indicating a set of multiple bitrates and a set of multiple QoE metrics corresponding to the set of multiple bitrates for the operations at the UE.

In some examples, the QoS profile manager 830 is capable of, configured to, or operable to support a means for outputting, to one or more network nodes of a wireless communications system, a third message indicating an update to the QoS profile, where the update indicates an updated QoE level corresponding to the first bitrate associated with the QoS profile, where the third message is output based on an update periodicity associated with the operations at the UE, one or more application content changes associated with the operations at the UE, or both.

In some examples, the QoE metric manager 855 is capable of, configured to, or operable to support a means for obtaining, from the one or more network nodes, an indication of a QoE metric associated with communications between the UE and the one or more network nodes, where the third message is output based on the indication of the QoE metric.

In some examples, the one or more application content changes include one or more changes in video content complexity, extended reality content complexity, virtual reality content complexity, mixed reality content complexity, one or more changes in streaming content, or any combination thereof.

In some examples, the first message further includes an indication of a time duration over which the respective bitrates and the respective QoE levels associated with the set of multiple QoS profiles are expected to be maintained.

In some examples, the respective QoE levels of the set of multiple QoS profiles are associated with one or more QoS identifiers in accordance with one or more PCC configurations.

In some examples, the respective QoE levels of the set of multiple QoS profiles include minimum target QoE levels, ranges of QoE values, or both.

In some examples, the first message includes a PDU set metadata indicative of data traffic at the UE.

In some examples, the first message further indicates one or more prioritization metrics corresponding to the set of multiple QoS profiles. In some examples, the selection of the QoS profile from the set of multiple QoS profiles is based on the one or more prioritization metrics.

In some examples, the one or more network nodes include a NEF node, a PCF node, an SMF node, an AMF node, a RAN node, or any combination thereof.

In some examples, the set of multiple QoS profiles correspond to one or more SDFs based on the respective QoE levels of the set of multiple QoS profiles.

In some examples, the Nnef_AFSessionWithQoS-Response manager 850 is capable of, configured to, or operable to support a means for transmitting, to the one or more network nodes and in response to the second message indicative of the QoS profile, an application function session with QoS-create message, an application function session with QoS-update message, or both.

Additionally, or alternatively, the communications manager 820 may support wireless communications in accordance with examples as disclosed herein. The network-server communicating manager 840 is capable of, configured to, or operable to support a means for obtaining, from an application server, a first message indicative of a set of multiple QoS profiles for operations at a UE, where the set of multiple QoS profiles each indicate a respective bitrate corresponding to a respective QoE level for operations at the UE. In some examples, the QoS profile manager 830 is capable of, configured to, or operable to support a means for outputting a second message indicative of a QoS profile selected from the set of multiple QoS profiles, the QoS profile including a first bitrate configured to maintain a first QoE level at the UE. The UE-to-server relay manager 845 is capable of, configured to, or operable to support a means for communicating data between the application server and the UE in accordance with the QoS profile indicated via the second message.

In some examples, the first message includes an application function session with QoS message (e.g., Nnef_AFSessionWithQoS). In some cases, the first message may include AFSessionWithQoS-Create and/or AFSessionWithQoS-Update messages (e.g., Nnef_AFsessionWithQoS_Create request, Nnef_AFSessionWithQoS_Update request), or both.

In some examples, the first message indicates a QoE-bitrate curve associated with the set of multiple QoS profiles, the QoE-bitrate curve indicating a set of multiple bitrates and a set of multiple QoE metrics corresponding to the set of multiple bitrates for the operations at the UE.

In some examples, the QoS profile manager 830 is capable of, configured to, or operable to support a means for obtaining, from the application server, a third message indicating an update to the QoS profile, where the update indicates an updated QoE level corresponding to the first bitrate associated with the QoS profile, where the third message is obtained based on an update periodicity associated with the operations at the UE, one or more application content changes associated with the operations at the UE, or both.

In some examples, the QoE metric manager 855 is capable of, configured to, or operable to support a means for outputting, to the application server, an indication of a QoE metric associated with communications between the UE and the network node, where the third message is obtained based on outputting the indication of the QoE metric.

In some examples, the QoE metric manager 855 is capable of, configured to, or operable to support a means for obtaining, from the UE, a report indicating the QoE metric associated with the communications between the UE and the network node, where the indication of the QoE metric is output to the application server is based on obtaining the report.

In some examples, the one or more application content changes include one or more changes in video content complexity, extended reality content complexity, virtual reality content complexity, mixed reality content complexity, one or more changes in streaming content, or any combination thereof.

In some examples, the first message further includes an indication of a time duration over which the respective bitrates and the respective QoE levels associated with the set of multiple QoS profiles are expected to be maintained.

In some examples, the respective QoE levels of the set of multiple QoS profiles are associated with one or more QoS identifiers in accordance with one or more PCC configurations.

In some examples, the respective QoE levels of the set of multiple QoS profiles include minimum target QoE levels, ranges of QoE values, or both.

In some examples, the first message further includes a PDU set metadata indicative of data traffic at the UE.

In some examples, the first message further indicates one or more prioritization metrics corresponding to the set of multiple QoS profiles. In some examples, the selection of the QoS profile from the set of multiple QoS profiles is based on the one or more prioritization metrics.

In some examples, the network node includes a NEF node, a PCF node, an SMF node, an AMF node, a RAN node, or any combination thereof.

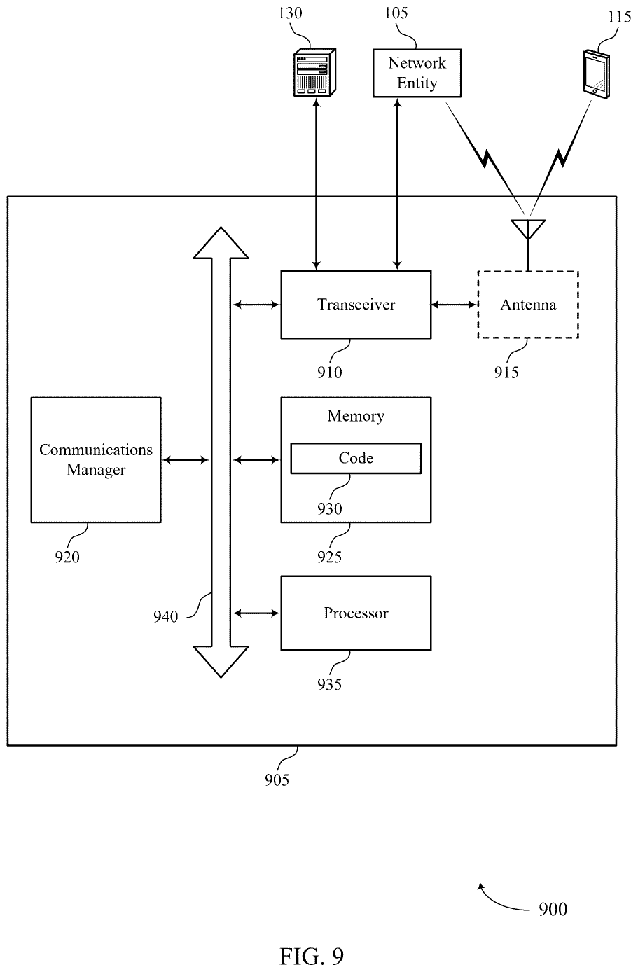

FIG. 9 shows a diagram of a system 900 including a device 905 that supports QoS profiles for UX awareness in accordance with one or more aspects of the present disclosure. The device 905 may be an example of or include components of a device 605, a device 705, or a network entity 105 as described herein. The device 905 may communicate with other network devices or network equipment such as one or more of the network entities 105, UEs 115, or any combination thereof. The communications may include communications over one or more wired interfaces, over one or more wireless interfaces, or any combination thereof. The device 905 may include components that support outputting and obtaining communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting QoS profiles for UX awareness). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for outputting, to one or more network nodes of a wireless communications system, a first message indicative of a set of multiple QoS profiles for operations at a UE, where the set of multiple QoS profiles each indicate a respective bitrate corresponding to a respective QoE level for operations at the UE. The communications manager 920 is capable of, configured to, or operable to support a means for obtaining a second message indicative of a QoS profile selected from the set of multiple QoS profiles, the QoS profile including a first bitrate configured to maintain a first QoE level at the UE. The communications manager 920 is capable of, configured to, or operable to support a means for communicating data with the UE via the one or more network nodes in accordance with the QoS profile indicated via the second message.

Additionally, or alternatively, the communications manager 920 may support wireless communications in accordance with examples as disclosed herein. For example, the communications manager 920 is capable of, configured to, or operable to support a means for obtaining, from an application server, a first message indicative of a set of multiple QoS profiles for operations at a UE, where the set of multiple QoS profiles each indicate a respective bitrate corresponding to a respective QoE level for operations at the UE. The communications manager 920 is capable of, configured to, or operable to support a means for outputting a second message indicative of a QoS profile selected from the set of multiple QoS profiles, the QoS profile including a first bitrate configured to maintain a first QoE level at the UE. The communications manager 920 is capable of, configured to, or operable to support a means for communicating data between the application server and the UE in accordance with the QoS profile indicated via the second message.

By including or configuring the communications manager 920 in accordance with examples as described herein, the device 905 may support techniques for QoE/UX-aware QoS selection, which may enable reduced processing and distributed processing, more efficient utilization of communication resources, more effective coordination between network devices providing advanced applications.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of QoS profiles for UX awareness as described herein, or the at least one processor 935 and the at least one memory 925 may be otherwise configured to, individually or collectively, perform or support such operations.

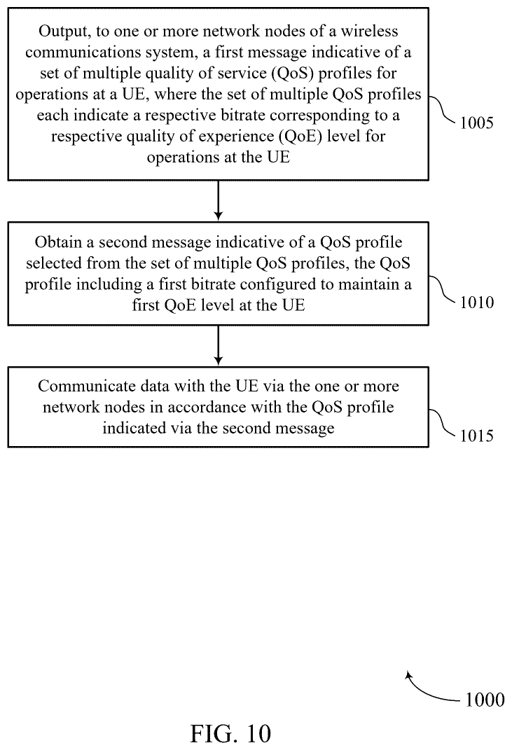

FIG. 10 shows a flowchart illustrating a method 1000 that supports QoS profiles for UX awareness in accordance with one or more aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include outputting, to one or more network nodes of a wireless communications system, a first message indicative of a set of multiple QoS profiles for operations at a UE, where the set of multiple QoS profiles each indicate a respective bitrate corresponding to a respective QoE level for operations at the UE. The operations of 1005 may be performed in accordance with examples as disclosed herein. In some examples, aspects of the operations of 1005 may be performed by a server-network communicating manager 825 as described with reference to FIG. 8.

At 1010, the method may include obtaining a second message indicative of a QoS profile selected from the set of multiple QoS profiles, the QoS profile including a first bitrate configured to maintain a first QoE level at the UE. The operations of 1010 may be performed in accordance with examples as disclosed herein. In some examples, aspects of the operations of 1010 may be performed by a QoS profile manager 830 as described with reference to FIG. 8.

At 1015, the method may include communicating data with the UE via the one or more network nodes in accordance with the QoS profile indicated via the second message. The operations of 1015 may be performed in accordance with examples as disclosed herein. In some examples, aspects of the operations of 1015 may be performed by a server-UE communicating manager 835 as described with reference to FIG. 8.

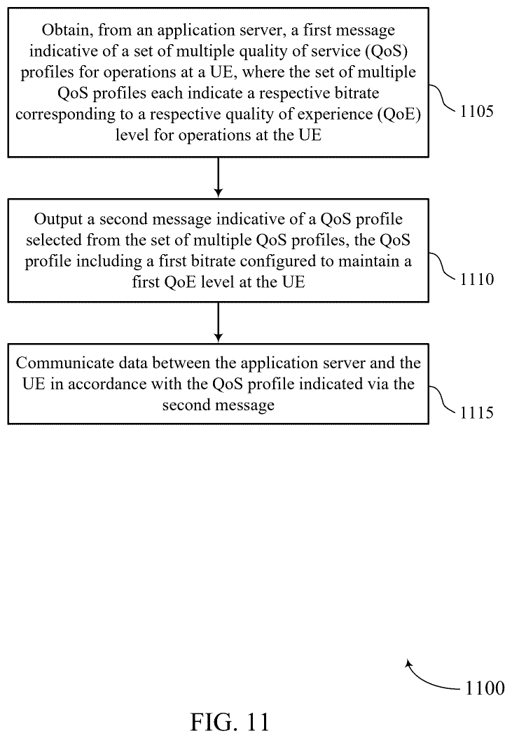

FIG. 11 shows a flowchart illustrating a method 1100 that supports QoS profiles for UX awareness in accordance with one or more aspects of the present disclosure. The operations of the method 1100 may be implemented by a network entity or its components as described herein. For example, the operations of the method 1100 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1105, the method may include obtaining, from an application server, a first message indicative of a set of multiple QoS profiles for operations at a UE, where the set of multiple QoS profiles each indicate a respective bitrate corresponding to a respective QoE level for operations at the UE. The operations of 1105 may be performed in accordance with examples as disclosed herein. In some examples, aspects of the operations of 1105 may be performed by a network-server communicating manager 840 as described with reference to FIG. 8.

At 1110, the method may include outputting a second message indicative of a QoS profile selected from the set of multiple QoS profiles, the QoS profile including a first bitrate configured to maintain a first QoE level at the UE. The operations of 1110 may be performed in accordance with examples as disclosed herein. In some examples, aspects of the operations of 1110 may be performed by a QoS profile manager 830 as described with reference to FIG. 8.

At 1115, the method may include communicating data between the application server and the UE in accordance with the QoS profile indicated via the second message. The operations of 1115 may be performed in accordance with examples as disclosed herein. In some examples, aspects of the operations of 1115 may be performed by a UE-to-server relay manager 845 as described with reference to FIG. 8.

The following provides an overview of aspects of the present disclosure:

Aspect 1: A method for wireless communications at an application server, comprising: outputting, to one or more network nodes of a wireless communications system, a first message indicative of a plurality of QoS profiles for operations at a UE, wherein the plurality of QoS profiles each indicate a respective bitrate corresponding to a respective QoE level for operations at the UE; obtaining a second message indicative of a QoS profile selected from the plurality of QoS profiles, the QoS profile comprising a first bitrate configured to maintain a first QoE level at the UE; and communicating data with the UE via the one or more network nodes in accordance with the QoS profile indicated via the second message.

Aspect 2: The method of aspect 1, wherein the first message comprises an AFSessionWithQoS message.

Aspect 3: The method of any of aspects 1 through 2, wherein the first message indicates a QoE-bitrate curve associated with the plurality of QoS profiles, the QoE-bitrate curve indicating a plurality of bitrates and a plurality of QoE metrics corresponding to the plurality of bitrates for the operations at the UE.

Aspect 4: The method of any of aspects 1 through 3, further comprising: outputting, to one or more network nodes of a wireless communications system, a third message indicating an update to the QoS profile, wherein the update indicates an updated QoE level corresponding to the first bitrate associated with the QoS profile, wherein the third message is output based at least in part on an update periodicity associated with the operations at the UE, one or more application content changes associated with the operations at the UE, or both.

Aspect 5: The method of aspect 4, further comprising: obtaining, from the one or more network nodes, an indication of a QoE metric associated with communications between the UE and the one or more network nodes, wherein the third message is output based at least in part on the indication of the QoE metric.

Aspect 6: The method of any of aspects 4 through 5, wherein the one or more application content changes comprise one or more changes in video content complexity, XR content complexity, VR content complexity, mixed reality content complexity, one or more changes in streaming content, or any combination thereof.

Aspect 7: The method of any of aspects 1 through 6, wherein the first message further comprises an indication of a time duration over which the respective bitrates and the respective QoE levels associated with the plurality of QoS profiles are expected to be maintained.

Aspect 8: The method of any of aspects 1 through 7, wherein the respective QoE levels of the plurality of QoS profiles are associated with one or more QoS identifiers in accordance with one or more PCC configurations.

Aspect 9: The method of any of aspects 1 through 8, wherein the respective QoE levels of the plurality of QoS profiles comprise minimum target QoE levels, ranges of QoE values, or both.

Aspect 10: The method of any of aspects 1 through 9, wherein the first message comprises a PDU set metadata indicative of data traffic at the UE.

Aspect 11: The method of any of aspects 1 through 10, wherein the first message further indicates one or more prioritization metrics corresponding to the plurality of QoS profiles, the selection of the QoS profile from the plurality of QoS profiles is based at least in part on the one or more prioritization metrics.

Aspect 12: The method of any of aspects 1 through 11, wherein the one or more network nodes comprise a NEF node, a PCF node, an SMF node, an AMF node, a UDM node, a RAN node, or any combination thereof.

Aspect 13: The method of any of aspects 1 through 12, wherein the plurality of QoS profiles are associated with one or more QoS flows, the one or more QoS flows correspond to one or more SDFs based at least in part on the respective QoE levels of the plurality of QoS profiles.

Aspect 14: The method of any of aspects 1 through 13, further comprising: transmitting, to the one or more network nodes and in response to the second message indicative of the QoS profile, an application function session with QoS-create message, an application function session with QoS-update message, or both.

Aspect 15: The method of any of aspects 1 through 14, wherein the one or more QoS profiles comprise one or more alternative QoS profiles usable for communications between an SMF node and a RAN node.

Aspect 16: A method for wireless communications at a network node, comprising: obtaining, from an application server, a first message indicative of a plurality of QoS profiles for operations at a UE, wherein the plurality of QoS profiles each indicate a respective bitrate corresponding to a respective QoE level for operations at the UE; outputting a second message indicative of a QoS profile selected from the plurality of QoS profiles, the QoS profile comprising a first bitrate configured to maintain a first QoE level at the UE; and communicating data between the application server and the UE in accordance with the QoS profile indicated via the second message.

Aspect 17: The method of aspect 16, wherein the first message comprises an AFSessionWithQoS messages.

Aspect 18: The method of any of aspects 16 through 17, wherein the first message indicates a QoE-bitrate curve associated with the plurality of QoS profiles, the QoE-bitrate curve indicating a plurality of bitrates and a plurality of QoE metrics corresponding to the plurality of bitrates for the operations at the UE.

Aspect 19: The method of any of aspects 16 through 18, further comprising: obtaining, from the application server, a third message indicating an update to the QoS profile, wherein the update indicates an updated QoE level corresponding to the first bitrate associated with the QoS profile, wherein the third message is obtained based at least in part on an update periodicity associated with the operations at the UE, one or more application content changes associated with the operations at the UE, or both.

Aspect 20: The method of aspect 19, further comprising: outputting, to the application server, an indication of a QoE metric associated with communications between the UE and the network node, wherein the third message is obtained based at least in part on outputting the indication of the QoE metric.

Aspect 21: The method of aspect 20, further comprising: obtaining, from the UE, a report indicating the QoE metric associated with the communications between the UE and the network node, wherein the indication of the QoE metric is output to the application server is based at least in part on obtaining the report.

Aspect 22: The method of any of aspects 19 through 21, wherein the one or more application content changes comprise one or more changes in video content complexity, XR content complexity, VR content complexity, mixed reality content complexity, one or more changes in streaming content, or any combination thereof.

Aspect 23: The method of any of aspects 16 through 22, wherein the first message further comprises an indication of a time duration over which the respective bitrates and the respective QoE levels associated with the plurality of QoS profiles are expected to be maintained.

Aspect 24: The method of any of aspects 16 through 23, wherein the respective QoE levels of the plurality of QoS profiles are associated with one or more QoS identifiers in accordance with one or more PCC configurations.

Aspect 25: The method of any of aspects 16 through 24, wherein the respective QoE levels of the plurality of QoS profiles comprise minimum target QoE levels, ranges of QoE values, or both.

Aspect 26: The method of any of aspects 16 through 25, wherein the first message further comprises a PDU set metadata indicative of data traffic at the UE.

Aspect 27: The method of any of aspects 16 through 26, wherein the first message further indicates one or more prioritization metrics corresponding to the plurality of QoS profiles, the selection of the QoS profile from the plurality of QoS profiles is based at least in part on the one or more prioritization metrics.

Aspect 28: The method of any of aspects 16 through 27, wherein the network node comprises a NEF node, a PCF node, an SMF node, an AMF node, a UDM node, a RAN node, or any combination thereof.

Aspect 29: An application server for wireless communications, comprising one or more memories storing processor-executable code, and one or more processors coupled with the one or more memories and individually or collectively operable to execute the code to cause the application server to perform a method of any of aspects 1 through 15.

Aspect 30: An application server for wireless communications, comprising at least one means for performing a method of any of aspects 1 through 15.

Aspect 31: A non-transitory computer-readable medium storing code for wireless communications, the code comprising instructions executable by one or more processors to perform a method of any of aspects 1 through 15.

Aspect 32: A network node for wireless communications, comprising one or more memories storing processor-executable code, and one or more processors coupled with the one or more memories and individually or collectively operable to execute the code to cause the network node to perform a method of any of aspects 16 through 28.

Aspect 33: A network node for wireless communications, comprising at least one means for performing a method of any of aspects 16 through 28.

Aspect 34: A non-transitory computer-readable medium storing code for wireless communications, the code comprising instructions executable by one or more processors to perform a method of any of aspects 16 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An application server, comprising:
one or more memories storing processor-executable code; and
one or more processors coupled with the one or more memories and individually or collectively operable to execute the code to cause the application server to:
output, to one or more network nodes of a wireless communications system, a first message indicative of a plurality of quality of service (QoS) profiles for operations at a user equipment (UE), wherein the plurality of QoS profiles each indicate a respective bitrate corresponding to a respective quality of experience (QoE) level for the operations at the UE;
obtain a second message indicative of a QoS profile selected from the plurality of QoS profiles, the QoS profile comprising a first bitrate configured to maintain a first QoE level at the UE; and
communicate data with the UE via the one or more network nodes in accordance with the QoS profile indicated via the second message.

2. The application server of claim 1, wherein the first message comprises an AFsessionWithQoS_Create message, an AFsessionWithQoS_Update message, or both.

3. The application server of claim 1, wherein the first message indicates a QoE-bitrate curve associated with the plurality of QoS profiles, the QoE-bitrate curve indicating a plurality of bitrates and a plurality of QoE metrics corresponding to the plurality of bitrates for the operations at the UE.

4. The application server of claim 1, wherein the one or more processors are individually or collectively further operable to execute the code to cause the application server to:
output, to the one or more network nodes of the wireless communications system, a third message indicating an update to the QoS profile, wherein the update indicates an updated QoE level corresponding to the first bitrate associated with the QoS profile, wherein the third message is output based at least in part on an update periodicity associated with the operations at the UE, one or more application content changes associated with the operations at the UE, or both.

5. The application server of claim 4, wherein the one or more processors are individually or collectively further operable to execute the code to cause the application server to:
obtain, from the one or more network nodes, an indication of a QoE metric associated with communications between the UE and the one or more network nodes, wherein the third message is output based at least in part on the indication of the QoE metric.

6. The application server of claim 4, wherein the one or more application content changes comprise one or more changes in video content complexity, extended reality content complexity, virtual reality content complexity, mixed reality content complexity, one or more changes in streaming content, or any combination thereof.

7. The application server of claim 1, wherein the first message further comprises an indication of a time duration over which the respective bitrates and the respective QoE levels associated with the plurality of QoS profiles are expected to be maintained.

8. The application server of claim 1, wherein the respective QoE levels of the plurality of QoS profiles are associated with one or more QoS identifiers in accordance with one or more policy and charging control (PCC) configurations.

9. The application server of claim 1, wherein the respective QoE levels of the plurality of QoS profiles comprise minimum target QoE levels, ranges of QoE values, or both.

10. The application server of claim 1, wherein the first message comprises a packet data unit (PDU) set metadata indicative of data traffic at the UE.

11. The application server of claim 1, wherein the first message further indicates one or more prioritization metrics corresponding to the plurality of QoS profiles, wherein the selection of the QoS profile from the plurality of QoS profiles is based at least in part on the one or more prioritization metrics.

12. The application server of claim 1, wherein the one or more network nodes comprise a Network Exposure Function (NEF) node, a Policy Control Function (PCF) node, a Session Management Function (SMF) node, an Access and Mobility Management Function (AMF) node, a Unified Data Management (UDM) node, a Radio Access Network (RAN) node, or any combination thereof.

13. The application server of claim 1, wherein the plurality of QoS profiles are associated with one or more QoS flows, wherein the one or more QoS flows correspond to one or more service data flows (SDFs) based at least in part on the respective QoE levels of the plurality of QoS profiles.

14. The application server of claim 1, wherein the second message comprises an AFsessionWithQoS_Notify message.

15. The application server of claim 1, wherein the one or more processors are individually or collectively further operable to execute the code to cause the application server to:
transmit, to the one or more network nodes and in response to the second message indicative of the QoS profile, an AFsessionWithQoS_Create message, an AFsessionWithQoS_Update message, or both.

16. The application server of claim 1, wherein the one or more QoS profiles comprise one or more alternative QoS profiles usable for communications between a Session Management Function (SMF) node and a Radio Access Network (RAN) node.

17. A network node, comprising:
one or more memories storing processor-executable code; and
one or more processors coupled with the one or more memories and individually or collectively operable to execute the code to cause the network node to:
obtain, from an application server, a first message indicative of a plurality of quality of service (QoS) profiles including alternative QoS profiles for operations at a user equipment (UE), wherein the plurality of QoS profiles each indicate a respective bitrate corresponding to a respective quality of experience (QoE) level for operations at the UE;
output a second message indicative of a QoS profile selected from the plurality of QoS profiles, the QoS profile comprising a first bitrate configured to maintain a first QoE level at the UE; and
communicate data between the application server and the UE in accordance with the QoS profile indicated via the second message.

18. The network node of claim 17, wherein the first message comprises an AFsessionWithQoS_Create message, an AFsessionWithQoS_Update message, or both.

19. The network node of claim 17, wherein the first message indicates a QoE-bitrate curve associated with the plurality of QoS profiles, the QoE-bitrate curve indicating a plurality of bitrates and a plurality of QoE metrics corresponding to the plurality of bitrates for the operations at the UE.

20. The application server of claim 17, wherein the second message comprises an AFsessionWithQoS_Notify message.

21. The network node of claim 17, wherein the one or more processors are individually or collectively further operable to execute the code to cause the network node to:
obtain, from the application server, a third message indicating an update to the QoS profile, wherein the update indicates an updated QoE level corresponding to the first bitrate associated with the QoS profile, wherein the third message is obtained based at least in part on an update periodicity associated with the operations at the UE, one or more application content changes associated with the operations at the UE, or both.

22. The network node of claim 21, wherein the one or more processors are individually or collectively further operable to execute the code to cause the network node to:
output, to the application server, an indication of a QoE metric associated with communications between the UE and the network node, wherein the third message is obtained based at least in part on outputting the indication of the QoE metric.

23. The network node of claim 22, wherein the one or more processors are individually or collectively further operable to execute the code to cause the network node to:
obtain, from the UE, a report indicating the QoE metric associated with the communications between the UE and the network node, wherein the indication of the QoE metric is output to the application server is based at least in part on obtaining the report.

24. The network node of claim 21, wherein the one or more application content changes comprise one or more changes in video content complexity, extended reality content complexity, virtual reality content complexity, mixed reality content complexity, one or more changes in streaming content, or any combination thereof.

25. The network node of claim 17, wherein the first message further comprises an indication of a time duration over which the respective bitrates and the respective QoE levels associated with the plurality of QoS profiles are expected to be maintained.

26. The network node of claim 17, wherein the respective QoE levels of the plurality of QoS profiles are associated with one or more QoS identifiers in accordance with one or more policy and charging control (PCC) configurations.

27. The network node of claim 17, wherein the respective QoE levels of the plurality of QoS profiles comprise minimum target QoE levels, ranges of QoE values, or both.

28. The network node of claim 17, wherein the first message further comprises a packet data unit (PDU) set metadata indicative of data traffic at the UE.

29. A method for wireless communications at an application server, comprising:
outputting, to one or more network nodes of a wireless communications system, a first message indicative of a plurality of quality of service (QoS) profiles for operations at a user equipment (UE), wherein the plurality of QoS profiles each indicate a respective bitrate corresponding to a respective quality of experience (QoE) level for operations at the UE;
obtaining a second message indicative of a QoS profile selected from the plurality of QoS profiles, the QoS profile comprising a first bitrate configured to maintain a first QoE level at the UE; and
communicating data with the UE via the one or more network nodes in accordance with the QoS profile indicated via the second message.

30. A method for wireless communications at a network node, comprising:
obtaining, from an application server, a first message indicative of a plurality of quality of service (QoS) profiles for operations at a user equipment (UE), wherein the plurality of QoS profiles each indicate a respective bitrate corresponding to a respective quality of experience (QoE) level for operations at the UE;
outputting a second message indicative of a QoS profile selected from the plurality of QoS profiles, the QoS profile comprising a first bitrate configured to maintain a first QoE level at the UE; and
communicating data between the application server and the UE in accordance with the QoS profile indicated via the second message.
